(19) United States
(12) Patent Application Publication
(10) Pub. No.: US 2018/0314034 A1
(43) Pub. Date: Nov. 1, 2018

(54) COMPOSITE SANDWICH MIRROR PANEL USEFUL IN CONCENTRATED SOLAR POWER SYSTEMS

(71) Applicant: SOLARRESERVE TECHNOLOGY, LLC, Santa Monica, CA (US)

(72) Inventors: Christian Gregory, La Crescenta, CA (US); Gregory Gates, Golden, CO (US)

(21) Appl. No.: 15/569,563

(22) PCT Filed: Apr. 28, 2016
(86) PCT No.: PCT/US2016/029753

§ 371 Date: Oct. 26, 2017

Related U.S. Application Data
(60) Provisional application No. 62/153,716, filed on Apr. 28, 2015.
(60) Provisional application No. 62/153,723, filed on Apr. 28, 2015.
(60) Provisional application No. 62/211,376, filed on Aug. 28, 2015.

(51) Int. Cl. G02B 7/18; G02B 7/183; G02B 5/08; G02B 19/00

(52) U.S. Cl. CPC G02B 7/181; G02B 7/183; H02S 40/22; G02B 19/0019; G02B 19/0042; G02B 5/085

(57) ABSTRACT

The present invention provides strategies for mitigating the deleterious effects of differential thermal expansion in composite panel structures. The principles of the present invention are particularly useful in the field of concentrating solar power. The principles of the present invention can be used in CSP applications to make composite mirror panel structures with improved characteristics for accommodating differential thermal expansion between components of the composite. Significantly, the composite mirrors structures can still be securely attached to other heliostat components such as a drive mechanism while still having the ability to accommodate differential thermal expansion between the skins of a composite mirror panel helps to limit energy losses due to slope errors.

### PRIORITY

This application claims the benefit of U.S. Provisional Patent Application Ser. No. 62/153,723, filed on Apr. 28, 2015; U.S. Provisional Patent Application Ser. No. 62/153,716, filed on Apr. 28, 2015; and U.S. Provisional Patent Application Ser. No. 62/211,376, filed on Aug. 28, 2015, which are incorporated herein by reference in their entirety for all purposes.

### FIELD OF THE INVENTION

The present invention is an improved mirror panel assembly used for reflecting light to a target. More specifically, this mirror panel approach is intended for use in applications related to the field of Concentrated Solar Power (CSP), such as for heliostats and solar troughs, among others.

### BACKGROUND

Solar power plants or other systems that collect and concentrate solar energy onto one or more centralized targets are well known in the art. The concentrated solar energy often is used to directly or indirectly produce electricity and/or heat. Direct conversion, often referred to as concentrating photovoltaics (CPV) occurs in some modes of practice when photovoltaic cells (also known as solar cells) serve as the target(s) to convert incident, concentrated solar energy into electricity using photovoltaic effects. Indirect conversion, often referred to as Concentrating Solar Power (CSP) occurs when thermal energy of the concentrated solar energy is used in some modes of practice to heat a working fluid, or sequence of working fluids, that in turn drives machinery such as a turbine system to generate electric power. Working fluids include steam, oil, molten salt, or the like.

U.S. Pat. Nos. 8,833,076; 8,697,271; 7,726,127; 7,299,633; and U.S. Pat. Pub. No. 213/0081394 A1 describe systems in which solar energy heats molten salt to store the thermal energy. The molten salt can store the heat for extended periods of time for later use on demand. The molten salt thus functions as a thermal battery in this regard that is charged by the sun. The molten salt in turn is used in illustrative modes of practice to heat steam that drives a turbine to generate electricity. After heating the steam, the molten salt cools down but is readily heated again, or re-charged with solar energy, by heating again using concentrated solar energy. Molten salt can be heated, used, and recharged this way many times without being consumed to any significant degree. Facilities that use molten salt in this fashion are projected to have lifespans extending for decades.

CSP systems typically rely on a field of reflecting devices that track, reflect, and collectively concentrate incident sunlight onto a solar receiver. Many types of reflecting devices are known. Examples include heliostats, parabolic dishes, trough concentrators, and the like. A CSP system often may use hundreds or even thousands of reflecting devices to concentrate solar energy.

Mirrors in most instances are a fundamental element of the reflecting devices used in CSP plants. The primary function of the mirrors is to reflect sunlight onto a target where the resultant concentrated sunlight can then be converted into other forms of useful energy, such as electricity or heat. Mirrors may have a variety of shapes, and many shapes are suitable to redirect sunlight onto a desired target. As examples of shapes, mirrors may be flat, curved in two dimensions, curved in three dimensions, faceted, and the like.

The mirrors often are supported by a suitable support structure so that the mirrors substantially maintain their shape without undue sagging, thermal deformation, or shape deformation as the mirrors articulate and are impacted by wind, moisture, age, temperature changes, and other surrounding factors. An important factor that affects energy delivery over time is any deviation between the actual mirror shape and the intended mirror shape, or slope error. A goal is to limit this slope error to desired tolerances. The degree to which slope errors are tolerated is referred to as the slope error budget. In order to maintain a desired shape, the mirror is generally integrated with a suitable support structure. This supporting structure, together with the mirror, comprises at least a portion of a mirror panel assembly.

A mirror panel is a component of many different types of reflector devices. A heliostat is one type of reflector device. A heliostat is a term in the art that refers to an assembly comprising one or more mirror panel assemblies, one or more drive mechanisms attached to the mirror panel to articulate the mirror panel to track the sun, and a base structure mounted to the drive mechanism to attach the heliostat to the ground, a frame, or other fixed or moveable mounting site. Trough reflectors are another type of reflecting device.

The adverse impact of slope errors becomes more pronounced with increasing distance from the target. This is less of an issue with solar trough reflectors as often these are integrated into CSP systems in which the mirror-to-target distance is relatively low and where the mirror-to-target distance is similar for all mirror panels. On the other hand, heliostats are more often used in CSP systems that typically have much longer distances between the mirror panels and the target. In some systems, this distance can be up to a mile or more. Heliostat-based CSP systems of this magnitude, therefore, are less tolerant to slope error and may experience significant losses in energy production if the slope errors are too large.

Minimizing slope errors is a key aspect of heliostat engineering. From design, through fabrication and assembly, and ultimately through the performance under operating conditions, there are a number of factors that influence the slope error characteristics of the mirror panel assembly. A key factor is the influence of temperature changes and differential thermal expansion characteristics between the glass and supporting structure.

Composite sandwich construction is well known. A composite sandwich panel assembly typically includes two stressed skins separated by and bonded to a core material. The attachment between the core and skins is usually accomplished using some type of adhesive and/or mechanical coupling. The resulting panel structure often uses materials efficiently for the stiffness and strength achieved.

Ongoing efforts to implement a composite sandwich panel as a mirror panel structure have been attempted. Exemplary composite sandwich structures are described in U.S. Pat. No. 8,132,391 B2 and U.S. Pat. No. 8,327,604 B2. Instead of making the core from a separate piece of material, the core structure in these designs is formed as tabs that are an integral part of one of the skins. This is achieved by perforating a metal sheet at regular intervals and folding up “riser elements” perpendicular to the parent material of the skin. The tips of the riser elements are folded over to create tabs that are bonded to the back side of the top sheet of skin material to form the composite structure.

In the past, this structure has been used in parabolic troughs but is now being considered for heliostat applications. One particular configuration under development uses a backer sheet with integral riser elements that are bonded to the back side of another continuous sheet of the same material to form the sandwich panel. A reflective film is adhered to the front side of the continuous sheet to create a mirror surface.

One of the potential challenges associated with this approach is that it results in differential thermal expansion between the composite panel and the reflector mounted to it. This could result in undue slope error issues with a glass mirror if steps are not taken to accommodate the relative movement attributed to thermal expansion differences.

An alternative configuration under consideration replaces the top skin of the composite structure with a glass mirror. However, possible slope error effects caused by differential thermal expansion between the two skins must still be considered. Without being able to more effectively accommodate thermal expansion effects, it may be difficult for such composite panel designs to be effectively used as mirror panels of heliostat-based systems.

### SUMMARY OF THE INVENTION

The present invention provides strategies for reducing the harmful effects of differential thermal expansion in composite panel structures. The principles of the present invention are particularly useful in the field of concentrating solar power. The principles of the present invention can be used in CSP applications to make composite mirror panel structures with improved characteristics for accommodating differential thermal expansion between components of the composite. Significantly, the composite mirror structures can still be securely attached to other heliostat components such as a drive mechanism while still having the ability to accommodate differential thermal expansion between the skins of a composite mirror panel, which helps to limit energy losses due to slope errors. The design approach directly addresses slope error issues associated with differential thermal expansion between composite skins.

In illustrative modes of practice, the composite structures of the present invention include first and second skins that are coupled by a core having a structure that allows the shear stiffness of the panel to be tuned as desired. The panel can be stiffer near one or more reference locations, such as near an attachment site to other components, while also being less stiff farther from those one or more locations. Indeed, the stiffness can be tailored to gradually decrease with increasing distance from an attachment site or other designated reference location(s). One purpose of modulating the shear stiffness in this manner is to more closely correlate the stiffness to the differential thermal expansion motion of the skins to thereby minimize panel stresses that could cause slope errors. In some embodiments a reference location may be selected to coincide with an attachment site, but in other embodiments the designated reference location and an attachment site may be at different locations.

For example, at a location near the attachment region where a mirror panel is attached to another heliostat component, the relative radial motion between the back skin and front skin due to temperature changes tends to be low. The panel can be quite stiff proximal to such attachment point without the high stiffness leading to slope errors when temperature changes. However, further away from the attachment point, the relative radial motion between the skins tends to be greater when temperature changes. If the shear stiffness remained constant throughout the panel, the resultant thermal stresses farther away from the attachment point would be greater. Fabricating the composite so that it is less stiff at those greater distances reduces the stresses. This to mitigates the impact of thermal expansion more effectively, helping to reduce slope errors.

In addition to maintaining an appropriate shear stiffness profile to address temperature-induced slope errors, the mirror panel assembly advantageously may be suitably stiff in bending to resist slope errors caused by gravity and wind loads. Since the sandwich panel bending stiffness directly correlates to the shear stiffness, the interplay between the two is desirably considered in order to optimize a mirror panel assembly design. At first glance, this may appear to be problematic. Intuition might suggest that reducing shear stiffness would be achieved at the expense of bending stiffness. Fortunately, a synergy exists between bending stiffness and shear stiffness when the shear stiffness profile of the panel is tailored to be high where needed for overall stiffness and lower where needed to mitigate differential thermal expansion. In particular, the present invention appreciates that bending stiffness can be higher near an attachment site or other designated reference site where bending stresses are higher. However, bending stiffness may decrease as a function of distance from the attachment point without resulting in unduly higher deflection. At the same time, shear stiffness is beneficially higher near the attachment point where thermal stresses and risk of relative skin movement is lowest, but is beneficially lower farther from the attachment point where thermal stresses and risk of relative movement are greater.

As another key advantage, the present invention allows a greater range of skins to be used for the top or bottom skins of a composite structure. In the past, designers may have restricted design choices to top and bottom skins with matching or similar coefficients of thermal expansion in order to help mitigate differential thermal expansion effects. But, by using core features to accommodate these effects, design choices are expanded so that more optimum materials can be selected for the skins, without placing as much restriction on the coefficients of thermal expansion. The present invention is particularly useful when the bottom skin and top skin are made from materials with different coefficients of thermal expansion, as is commonly the case when optimizing performance.

In some embodiments, incorporation of a glass mirror as part of the composite structure reduces the amount of additional structural material needed to achieve a desired stiffness and stiffness profile. This advantage can result in a lighter weight or stronger panel, which may provide cost and handling or performance benefits. Incorporation of the glass mirror as part of the structure also helps to avoid moisture infiltration between the glass and omitted additional structure, thus also avoiding possible later corrosion caused by that moisture infiltration.

Thermal expansion compensation characteristics may allow the use of aluminum as the bottom skin material without exceeding the slope error budget. Aluminum can help to reduce the panel assembly weight further and help eliminate the need for a coating on the bottom skin to resist environmental exposure. Aluminum is more difficult to integrate into heliostat designs that mitigate differential thermal expansion less effectively.

Because of the relatively close spacing of the core elements used to couple composite skins, the use of thinner glass as a top skin may be feasible. This can help reduce the panel assembly weight further and can result in better mirror reflectivity. Note, however, that if the glass were too thin, the shear stiffness of a panel may be lower than desired. At some thickness threshold, a minimum stiffness required to resist gravity or wind loads may be an important design variable to select a suitable thickness of a glass panel. A significant advantage of the present invention is that core elements may be used to tune stiffness, including reducing or increasing stiffness, to allow thinner glass sheets to be more easily incorporated into designs.

In one aspect, the present invention relates to an articulating heliostat comprising a mirror panel assembly, wherein the mirror panel assembly comprises:

(a) a bottom component comprising (i) an upper surface (ii) a lower surface and (iii) at least one reference site, and;

(b) a top component that is spaced apart from the bottom component and that has a bottom surface and a reflective upper surface effective to redirect incident sunlight; and

(c) a core component interposed between the bottom component and the top component and comprising a plurality of spaced apart core elements that couple the bottom component to the top component in a spaced apart fashion, wherein the core elements are provided in a manner such that at least a portion of the mirror panel assembly has a relatively high shear stiffness proximal to the reference site and a relatively low shear stiffness distal from the reference site.

In another aspect, the present invention relates to a composite panel assembly, comprising:

(a) a first skin;

(b) a second skin; and

(c) a core coupling the first skin to the second skin in spaced apart fashion wherein the core comprises a plurality of spaced apart folded tabs that are integrally formed from at least one of the first and second skins and wherein the tabs are configured to provide the composite panel with a shear stiffness that decreases with increasing distance from a designated reference site of the composite panel assembly.

In another aspect, the present invention relates to a concentrating solar power system, comprising:

(a) a central target; and

(b) a plurality of articulating heliostats that redirect and concentrate sunlight onto the central target, wherein at least one of the heliostats comprises a mirror panel assembly that comprises:
(i) a bottom component comprising (i) an upper surface (ii) a lower surface and (ii) a reference site, and;
(ii) a top component that is spaced apart from the bottom component and that has a bottom surface and a reflective upper surface effective to redirect incident sunlight; and
(iii) a core component interposed between the bottom component and the top component and comprising a plurality of spaced apart core elements that couple the bottom component to the top component in a spaced apart fashion, wherein the core elements are provided in a manner such that at least a portion of the mirror panel assembly has a relatively high shear stiffness proximal to the reference site and a relatively low shear stiffness radially distal from the reference site.

In another aspect, the present invention relates to a method of making a heliostat, comprising the steps of:

(a) providing a mirror panel assembly, comprising the steps of:
(i) providing a bottom skin having a bottom surface and a top surface;
(ii) providing a top skin having a bottom surface and a reflective top surface effective to redirect incident sunlight;
(iii) identifying a reference site on the bottom skin; and
(iv) using a plurality of spaced apart core elements to couple the bottom skin to the top skin in a spaced apart fashion such that the mirror panel assembly has a relatively high shear stiffness proximal to the reference site and a relatively lower shear stiffness distal from the reference site; and

(b) attaching an additional heliostat component to the reference site of the mirror panel assembly.

### BRIEF DESCRIPTION OF THE DRAWINGS

FIG. 1 is a schematic illustration of a concentrated solar power system showing incorporating principles of the present invention.

FIG. 2 schematically illustrates a heliostat used in the power system of FIG. 1, wherein the heliostat uses a composite mirror panel of the present invention.

FIG. 3 is a graph showing relative movement between skins of a composite panel as a function of distance from a common attachment point.

FIG. 4A is a top, isometric view of composite mirror panel used in the heliostat of FIG. 2.

FIG. 4B is bottom, isometric view of composite mirror panel used in the heliostat of FIG. 2.

FIG. 4C is a top, schematic view of the composite mirror panel used in the heliostat of FIG. 2.

FIG. 4D is a detailed view of core elements on the base skin of FIG. 2.

FIG. 5A is a top isometric view of an alternative embodiment of a composite mirror panel including a skirt feature.

FIG. 5B is a top, exploded isometric view of the composite mirror panel of FIG. 5A.

FIG. 6A is a top isometric view of an alternative embodiment of a composite mirror panel including a skirt feature.

FIG. 6B is a top, exploded isometric view of the composite mirror panel of FIG. 6A.

FIG. 7A is a top isometric view of an alternative embodiment of a composite mirror panel including a skirt feature.

FIG. 7B is a top, exploded isometric view of the composite mirror panel of FIG. 7A.

FIG. 8 schematically illustrates how an involute curve may be used to lay out core elements on a bottom skin.

FIG. 9 schematically shows how first and second involute curves may be used to lay out core elements on a bottom skin.

FIG. 10 schematically shows how an involute curve may be used to layout core elements and reinforcing ribs on a bottom skin.

FIG. 11 schematically shows a deployment plan for laying out core elements having widths that linearly decrease with increasing distance from a common reference location.

FIG. 12A shows a front isometric view of designs for core elements that allow the stiffness of the core elements to be tuned.

FIG. 12B shows a rear isometric view of the designs of FIG. 12A.

FIG. 13 is a graph showing how moment of inertia varies with rotation angle relative to radial vector between a core element and a common reference site.

FIG. 14 schematically shows a deployment plan for laying out core elements having a common angular orientation and widths that decrease with increasing distance from a common reference location.

FIG. 15 is a graph that shows how the moment of inertia of tabs oriented at a given angle vary as the tab width is adjusted.

FIG. 16 schematically shows a deployment plan for laying out core elements having constant widths but a variable angular orientation in which the angular orientation with respect to a reference line increases with increasing distance from a common reference location.

FIG. 17 shows a portion of an alternative embodiment of a composite mirror panel, wherein the height of the core elements increases with increasing distance from a central, common reference location.

FIG. 18 shows a portion of an alternative embodiment of a composite mirror panel, wherein the core elements are angled to the top and bottom skins.

FIG. 19 shows a bottom, isometric view of an alternative embodiment of a composite mirror panel that includes mounting tabs integrally formed from a recess in the bottom skin of the panel.

FIG. 20 schematically shows an embodiment of a composite mirror panel assembly in which core elements have alternating angular orientation with respect to a common, centrally located reference location.

### DETAILED DESCRIPTION OF PRESENTLY PREFERRED EMBODIMENTS

The present invention will now be further described with reference to the following illustrative embodiments. The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

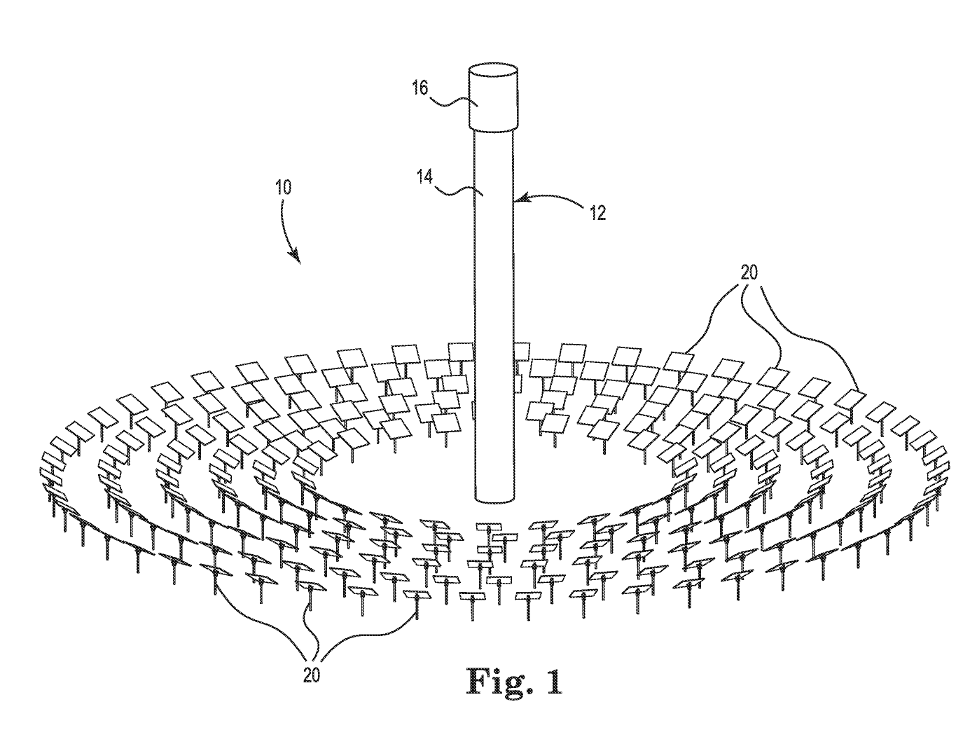

Referring to the figures and in particular FIG. 1, which schematically illustrates a concentrating solar energy system 10 that incorporates principles of the present invention. System 10 includes a central tower 12 including a mast 14 and a target region 16 at the top of the mast. A field of heliostats 20 is deployed around central tower 12. The heliostats 20 redirect and concentrate incident sunlight onto target region 16. If system 10 embodies a photovoltaic solar power system (a.k.a. concentrating photovoltaics, or CPV), target region 16 generally would include solar cells (not shown) that absorb the concentrated light and generate electricity that could then be stored for later use or distributed to one or more users or a power grid or the like. If system 10 embodies a concentrating solar power (CSP) system, used to convert thermal energy into electricity or mechanical energy (not shown), then the thermal energy generated on target region 16 may be used to heat a working fluid. The thermal energy in the heated fluid may then be used directly or indirectly to generate electricity or pressure. A CSP embodiment of system 10 is particularly useful in molten salt-based power systems such as those described in U.S. Pat. Nos. 8,833,076; 8,697,271; 7,726,127; 7,299,633; and U.S. Pat. Pub. No. 2013/0081394 A1.

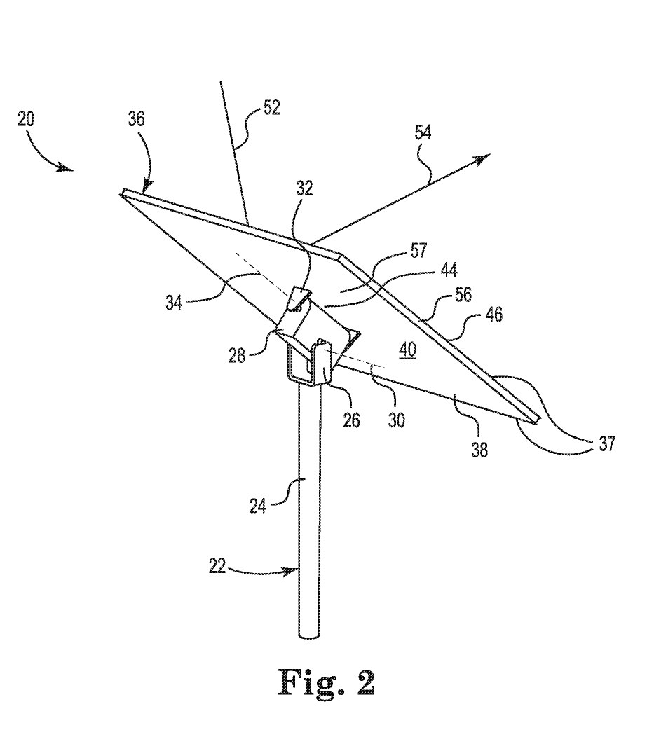

FIG. 2 schematically illustrates an exemplary embodiment of heliostat 20 used in system 10 of FIG. 1. Heliostat 20 includes a support structure 22 including a mast 24 and a first, fixed yoke 26. Yoke 26 is pivotably coupled to a drive mechanism 28. Drive mechanism 28 can be controllably actuated to pivot drive mechanism 28 around fixed, horizontal axis 30. Drive mechanism 28 is also pivotably coupled to second yoke 32. Drive mechanism can be actuated to controllably pivot yoke 32 about second axis 34. Yoke 32 is fixedly coupled to composite mirror panel 36. In practical effect, because drive mechanism 28 can control movement around both axes 30 and 34, composite mirror panel 36 can be articulated to aim in a manner effective to track the sun so that incident light ray 52 is reflected as reflected light ray 54 to be aimed at target region 16 (FIG. 1).

Composite mirror panel 36 includes bottom skin 38, top skin 46, and core 56. As schematically illustrated, core 56 is shown as a single region but in practice will comprise a plurality of core elements as described further below. FIG. 2 shows how bottom surface 40 of bottom skin 38 has a centrally located attachment site 44 to which yoke 32 is fixedly coupled. In accordance with principles of the present invention, core 56 is configured so that composite mirror panel has a shear stiffness that decreases with increasing distance from attachment site 44, which serves as a designated reference site in this embodiment. Thus, core 56 has relatively high shear stiffness proximal to attachment site 44 and relatively lower shear stiffness proximal to the perimeter 37 of composite mirror panel 36. In intermediate region 57, the shear stiffness is intermediate between the higher shear stiffness proximal to attachment site 44 and the lower shear stiffness proximal to perimeter 37.

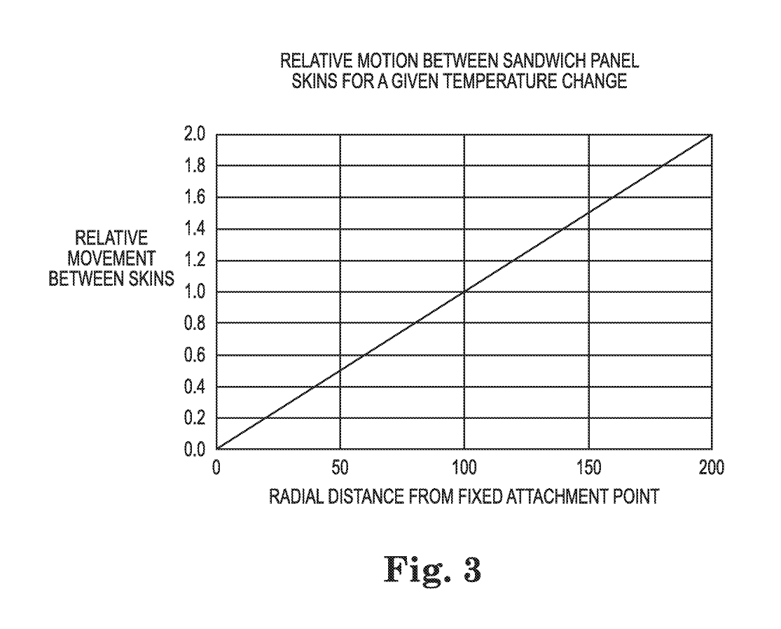

FIG. 3 graphically shows how providing panel 36 with a shear stiffness profile helps to mitigate differential thermal expansion. FIG. 3 shows relative movement between the skins of a composite for a given temperature change where the shear stiffness is generally uniform throughout the panel and the skins have different coefficients of thermal expansion. As a result of the temperature change, the skins will expand by different amounts, resulting in relative motion between the two skins. The skin movement is shown in FIG. 3 as a function of distance from a fixed attachment point. The graph shows the skin movement, and therefore thermal stresses are low proximal to an attachment site and steadily increase with distance.

The present invention teaches that a very effective way to reduce panel deformation is to provide a core material that provides decreasing shear stiffness with increasing distance from a designated reference site such as an attachment site. In practical effect, by using such a stiffness profile, thermal stresses are reduced, because shear stiffness desirably is lower at areas of higher potential movement. In preferred modes of practice, the invention teaches that the shear stiffness of the core material may be adjusted to be roughly inversely proportional to the relative motion between the skins. This can allow the stress level induced in the panel as a result of thermal deformations to remain somewhat constant throughout and thereby help to reduce slope errors that otherwise could result with temperature changes.

Desirably, the bending stiffness profile of composite mirror panel 36 is similar to the shear stiffness profile. That is, the bending stiffness is greatest proximal to attachment site 44 and desirably decreases with increasing distance from attachment site 44 toward perimeter 37. The design features of core 56 that provide the desired shear stiffness profile advantageously also provide the desired bending stiffness profile at the same time. In other words, both desired profiles are achieved by using design features that provide the desired shear stiffness profile.

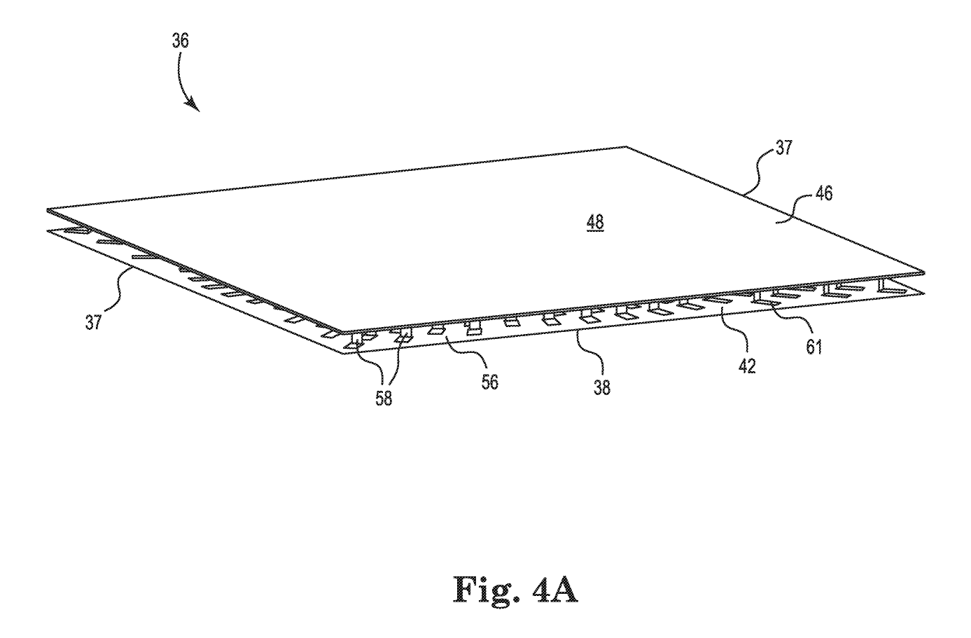

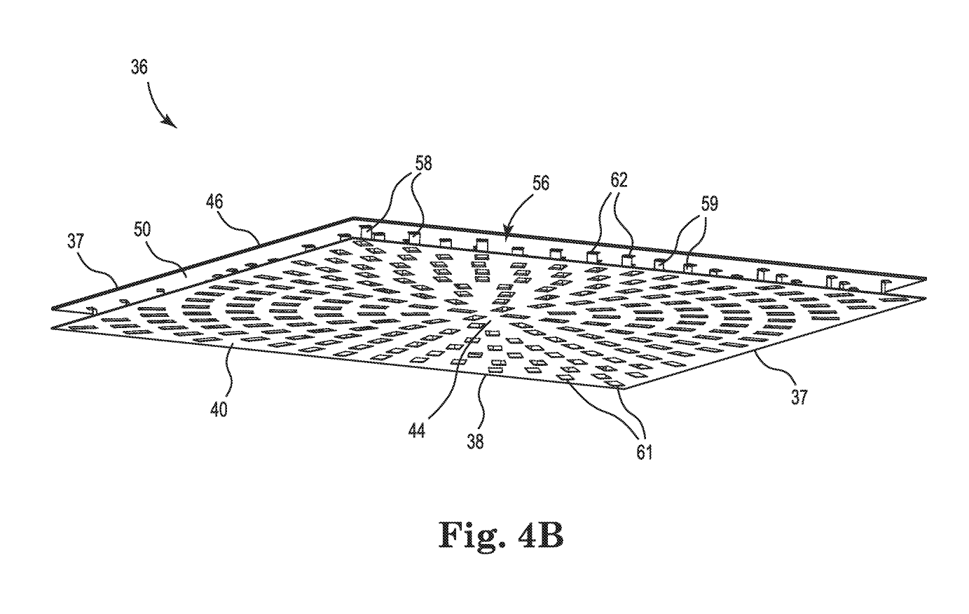

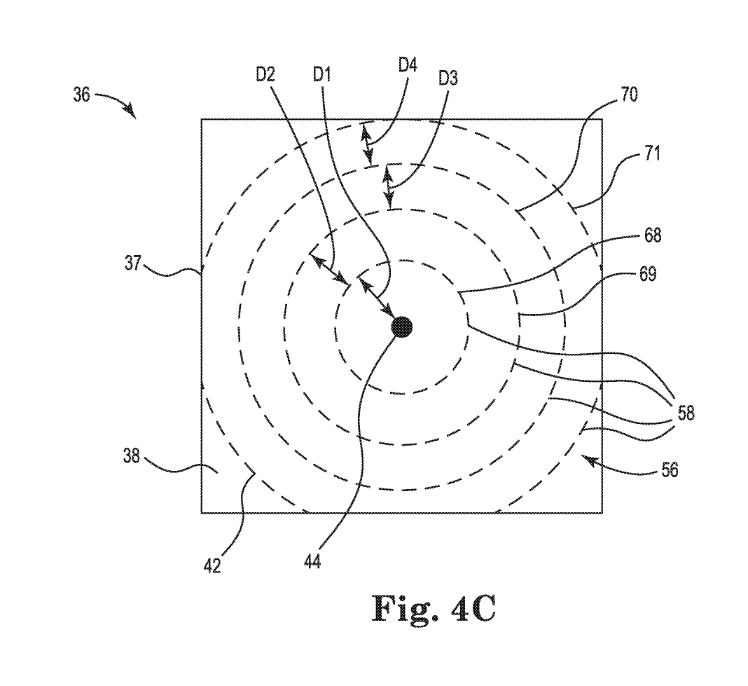

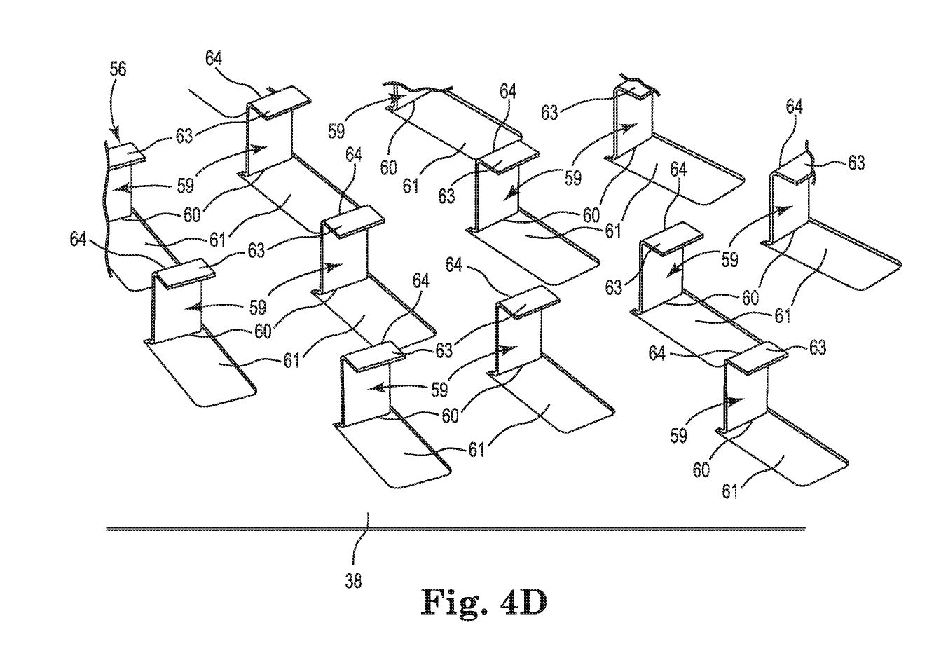

FIGS. 4A, 4B, 4C, and 4D show composite mirror panel assembly 36 in more detail. Bottom skin 38 is shown as having bottom surface 40 and top surface 42. Attachment site 44 is a region that in this embodiment is centrally located on the bottom surface 40. Panel 36 attaches to yoke 32 at this central location while the rest of panel 36 cantilevers outward from the centrally located attachment site 44. Top skin 46 has reflective top surface 48 and bottom surface 50.

Each of skins 38 and 46 independently may be formed from a single sheet of material or may be a laminate structure formed from two or more sheets. Each of skins 38 and 46 independently may be formed from a wide range of materials. In illustrative embodiments, bottom skin 38 may be formed from one or more metal alloys, polymers, reinforced composites, combinations of these, and the like. Preferred materials for forming bottom skin 38 include carbon steel, stainless steel, aluminum, combinations of these, or the like. In many embodiments, skin 38 has a thickness of 0.0127 centimeters to 0.635 centimeters (0.005 inches to 0.25 inches), or even 1.27 centimeters to 0.381 centimeters (0.05 inches to 0.15 inches). In illustrative embodiments, top skin 46 may be formed from a reflective sheet or a reflective sheet supported upon a suitable support sheet. Examples of reflective sheets include polished aluminum, float glass mirrors, reflective polymer films, combinations of these, and the like. If a reflective sheet is supported on an underlying support sheet, suitable materials for the support sheet can be selected from the same materials used to form the bottom sheet. In a specific embodiment, the bottom skin 38 is formed from an aluminum sheet having a thickness of 0.76 centimeters (0.03 inches) having a coefficient of thermal expansion of 0.000022 m/(mK), while the top skin 46 is formed from a glass mirror having a thickness of 0.305 centimeters (0.120 inches) and a coefficient of thermal expansion of about 0.000009 m/(mK).

Core 56 is interposed between skins 38 and 46 to support the skins 38 and 46 in a spaced apart relationship. Core 56 comprises a plurality of spaced apart core elements 58 that couple bottom skin 38 to top skin 46. Each core element 58 is integrally formed from a corresponding portion of bottom skin 38. The perimeter of each element 58 may be formed by separating the element 58 from skin 38 using any suitable technique such as shearing, punching, cutting, etching, combinations of these, or the like. The separation is accomplished to leave a base portion 59 by which element 58 remains attached to the skin 38. A bending line 60 extends across base portion 59 so that element 58 is bent upward from skin 38 toward skin 46. Corresponding openings 61 are incidentally formed in bottom skin 38 due to the formation of the core elements 58. The tips of elements 58 are bent at upper bend line 64 to form pads 63 for attaching elements 58 to the top skin 46. The attachment can occur in any suitable fashion such as by gluing, welding, brazing, riveting, clinching, or the like.

The core elements 58 are deployed and have a geometry so that the shear stiffness of panel 36 decreases with increasing distance from attachment site 44. In this embodiment, the desired shear stiffness is achieved by deploying core elements on concentric circles centered on the attachment site 44. This circular deployment is best seen in FIG. 4B and FIG. 4C.

Referring now to FIG. 4C, a top schematic view of bottom skin 38 is shown. For clarity, representative core elements 58 are shown, but the openings 61 in bottom skin 38 are not shown. Attachment site 44 is centrally located on bottom skin 38. A plurality of concentric rings 68, 69, 70, 71 can be visualized around the attachment site 44. In the schematic illustration, four such concentric rings are provided. In actual practice, a full size, actual composite mirror panel 36 would include many more of such rings, e.g, a total of 5 to 30 rings in representative embodiments. For example, one embodiment uses 20 concentric rings in combination with a top skin that includes a mirror having a surface area of 4 m².

A first ring 68 is at a distance d1 from the center of the attachment site. A second ring 69 is at a distance d2 from the center of the attachment site. Rings 70 and 71 are provided further out at comparable spacing intervals of d3 and d4. The radial spacing between concentric rings in an actual panel would be dependent on a number of factors including the area of the sandwich panel, the thickness, the desired minimum web dimension between the edges of the holes in the backer skin, and the thickness of the glass (which influences the allowable maximum distance between supports), among others. As suggested guidelines, spacing the rings so that the distance between rings is 3 to 10 cm would be suitable in many instances.

Concentric arrays of core elements 58 are deployed on each ring 68, 69, 70, and 71. The features (e.g., one or more of width, length, angular orientation, shape, etc.) of the core elements 58 are tuned so that the shear stiffness decreases on each ring successively outward from site 44. According to one embodiment, the elements 58 are oriented so that the faces of the elements 58 are generally perpendicular to a radial line from each element to the center of a reference site that in this embodiment coincides with attachment site 44. In order to achieve a profile in which shear stiffness decreases with increasing distance outward from the attachment site 44, the tab width of elements in each circular array decreases outward from site 44. Thus, the widest elements 58 are on ring 68. The width of the elements 58 then becomes narrower successively moving outward to rings 69, 70, 71, etc. As a consequence of reducing the element width successively in this manner, the composite radial stiffness of the elements 58 arranged on the innermost circle 68 should desirably be greater than the composite stiffness of the next ring, and so on. In this particular embodiment, elements 58 have uniform heights so that the spacing between skins 38 and 46 is uniform. In other embodiments described below, the height of elements 58 is another design parameter that can be modulated in order to tune shear stiffness properties of panel 36.

Desirably, the spacing between elements on each ring 68, 69, 70, and 71 should remain relatively consistent in order to help maintain the integrity of the composite sandwich panel structure. This means that the distances d1, d2, d3, and d4 desirably are substantially the same. As a consequence, embodiments of the invention using this design approach have a number of elements 58 on each ring that is approximately proportional to the circumference of the ring.

Advantageously, deploying the core elements 58 in concentric ring arrays around the attachment site 44 helps to simplify the design and analysis effort for achieving desired stiffness profile characteristics of panel 36. Because one desirable shear stiffness profile is to have shear stiffness decrease in a radial direction outward from site 44, a concentric layout pattern easily accommodates this type of arrangement. Of course, other deployment patterns of elements 58 may be used if desired. Alternative layout patterns are discussed below.

The top skin 46 generally will tend to absorb some degree of thermal energy from the incident sunlight. Due to factors including the manner in which the core elements 58 are integrally formed from the bottom skin 38 and the manner in which the core elements help to couple the skins 38 and 46 to each other in a spaced apart fashion, the combination of the bottom skin 38 and core elements 58 is believed to also function as an effective heat sink. The heat exchanger characteristics help to add or remove heat from the top skin 46. For example, when oriented at an angle relative to horizontal the composite panel assembly might experience natural convective heat transfer, depending on the temperature of the skins 38 and 46. This can help dissipate heat from the bottom and top skins 38 and 46. The convective flow helps to equilibrate both skins 38 and 46 to ambient temperature. This also could help heat the top skin 46 during colder weather. The heat transfer characteristics may be a significant benefit when colder temperatures otherwise could cause frost formation on the reflective surface 48 of top skin 46. In some embodiments, the bottom skin 38 may be painted a darker color and the heliostat 20 can be actuated to present that darker surface to the incident sunlight during cold mornings to enhance frost removal. Additionally, a thermally conductive adhesive may be used to bond the elements 58 to the top skin 46, enhancing heat exchange further.

In some embodiments, the use of an aluminum sheet to form bottom skin 38 can enhance the heat exchange properties even further due to the relatively high thermal conductivity of aluminum. In some embodiments, the use of a relatively thin glass sheet (e.g., a glass sheet having at thickness of 2 mm or less) to form the top skin 46 may be advantageous to help facilitate heat exchange to and from the non-insulated bottom surface 50 of the top skin. In such embodiments, the bottom surface 50 of such a glass sheet optionally may be reinforced with fibers to improve strength and durability of the sheet. Such fiber reinforcement not only would help with thermal stresses, but also stresses due to gravity, articulation, wind, hail strikes, and other loads. Techniques for providing such fiber reinforcement on glass sheets is described in U.S. Pat. Nos. 8,132,391 B2 and 8,327,604 B2.

Another technique to reinforce thin glass sheets used as top skin 46 comprises coating the bottom surface 50 with a fiber reinforced coating such as a fiber reinforced resin matrix, fiber reinforced paint, combinations of these, and the like. Exemplary fibers may be in the form of woven or non-woven mat or cloth, loose fibers mixed with the coating composition used to form the coating, oriented fibers, combinations of these, or the like. Exemplary fibers may be natural and/or synthetic and include fiberglass, carbon fiber, cellulosic fiber, ceramic fiber, polymeric fiber (such as the well-known Kevlar brand aramid fiber), metal alloy fibers, combinations of these, and the like. Using a fiber reinforced coating allows the top skin 46 to have improved toughness using easily applied, reliable coating techniques without the need to bond another laminate layer to form skin 46.

Composite mirror panels of the present invention may incorporate one or more additional features to help enhance heliostat characteristics and performance. An exemplary optional component is a perimeter skirt. As described in the SolarPACES 2013 paper Wind Load Reduction for Light-Weight Heliostat, by A. Pfahl, A. Brucks and C. Holze, wind tunnel testing has demonstrated that raised perimeter features on a mirror can reduce the hinge moment in a stowed position by up to 40%.

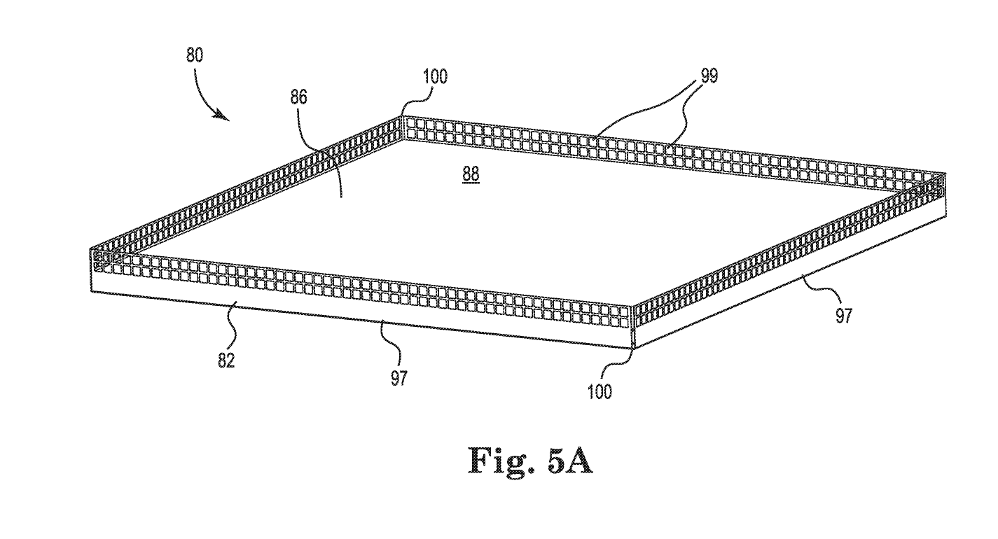

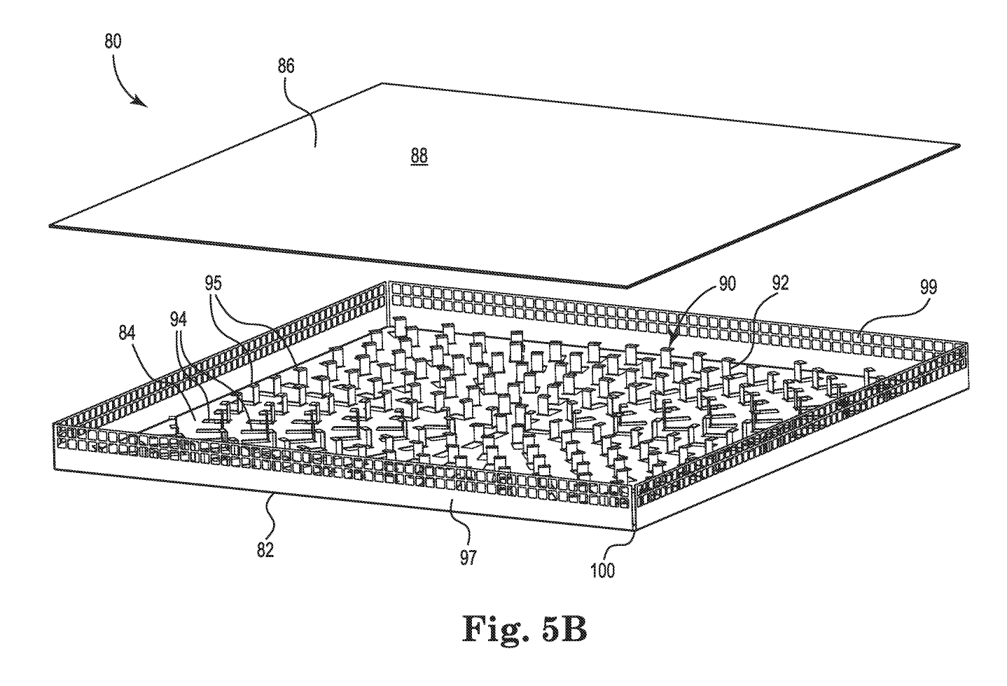

For example, FIGS. 5A and 5B show an embodiment of a composite mirror panel 80 that is similar to composite mirror panel 36 of FIGS. 1, 2, and 4A-4D except that composite mirror panel 80 incorporates a perimeter skirt feature 82. As shown in FIGS. 5A and 5B, composite mirror panel 80 includes bottom skin 84, top skin 86, and core 90. Top skin 86 includes top reflective surface 88 for redirecting sunlight at a target (not shown). Core 90 comprises a plurality of spaced apart core elements 92 that are integrally formed from bottom skin 84. The core elements 92 are folded upward, leaving openings 94 in the bottom skin 84. The tips 95 of elements 92 are folded over to provide tabs to attach the elements 92 to the top skin 86. Core elements 92 couple skins 84 and 86 in spaced apart fashion to form a composite structure.

Perimeter skirt 82 comprises walls 97 that are integrally formed with bottom skin 84 and are folded upward to extend beyond top skin 86. By providing an oversized sheet for bottom skin 84 and folding the edges, the perimeter skirt 82 is easily incorporated into the design. Walls 97 include perforations 99 to reduce weight, to allow water to drain off top skin 86, to reduce hinge moment torque, and to improve aerodynamic characteristics (e.g., reduced wind cross-section). The embodiment shown has a skirt that is about 50% porous. Corners 100 are open. The open corners and the openings 94 help to ventilate core 90 and also allow the core 90 to drain. Optionally, corners 100 can be wholly or partially sealed. Perimeter skirt 82 also function as heat exchange fins to facilitate thermal exchange and help cool the composite mirror panel 80.

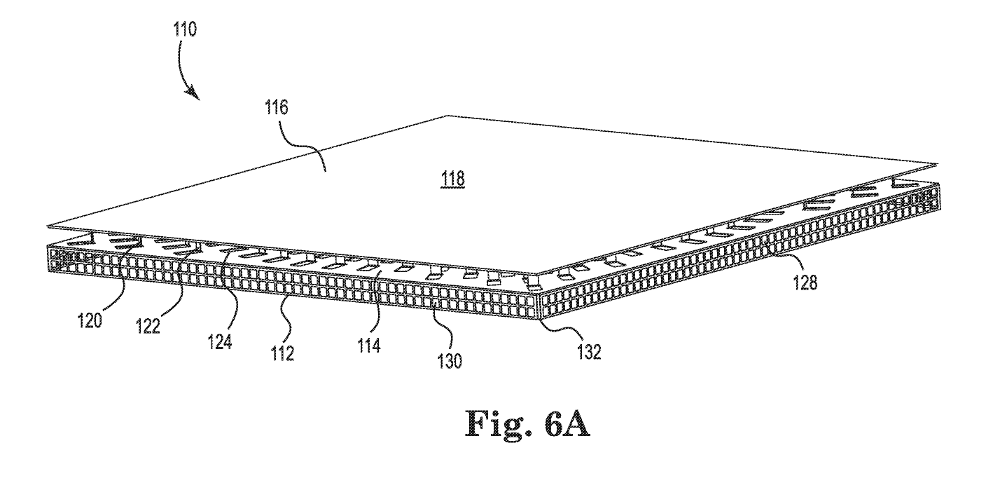

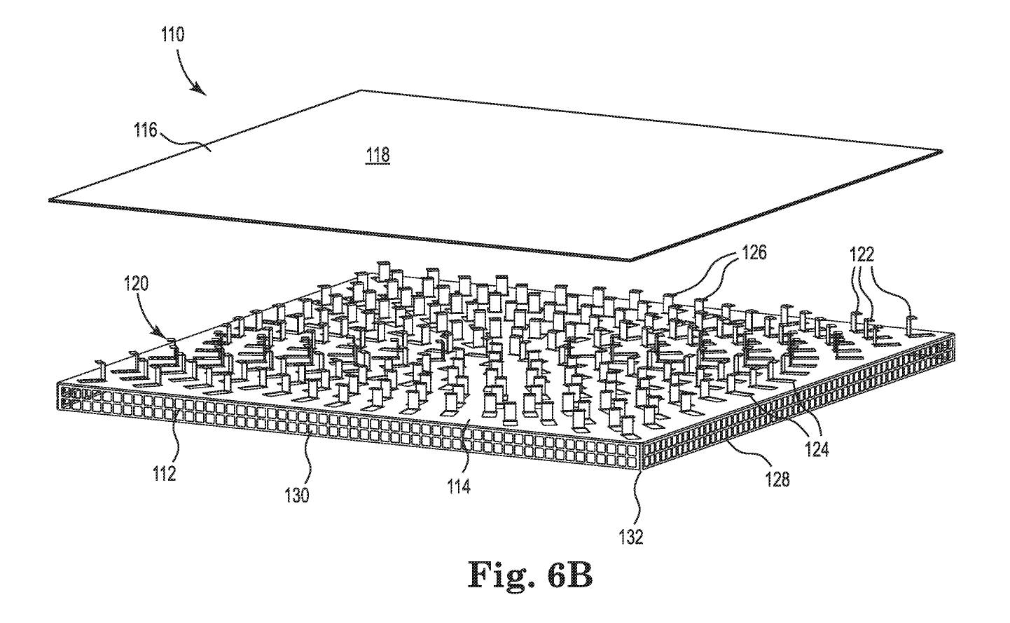

FIGS. 6A and 6B show another approach for providing another embodiment of a composite mirror panel 110 with a perimeter skirt 112. As shown in FIGS. 6A and 6B, composite mirror panel 110 includes bottom skin 114, top skin 116, and core 120. Top skin 116 includes top reflective surface 118 for redirecting sunlight at a target (not shown). Core 120 comprises a plurality of spaced apart core elements 122 that are integrally formed from bottom skin 114. The core elements 122 are folded upward, leaving openings 124 in the bottom skin 114. The tips 126 of elements 122 are folded over to provide tabs to attach the elements 122 to the top skin 116. Core elements 122 couple skins 114 and 116 in spaced apart fashion to form a composite structure.

Perimeter skirt 112 comprises walls 128 that are integrally formed with bottom skin 114 and are folded downward to extend below bottom skin 114. Walls 128 include perforations 130. Corners 132 are open but optionally can be wholly or partially sealed. Perimeter skirt 112 also functions as heat exchange fins to facilitate thermal exchange and help the composite mirror panel 110 to help maintain thermal equilibrium with the environment.

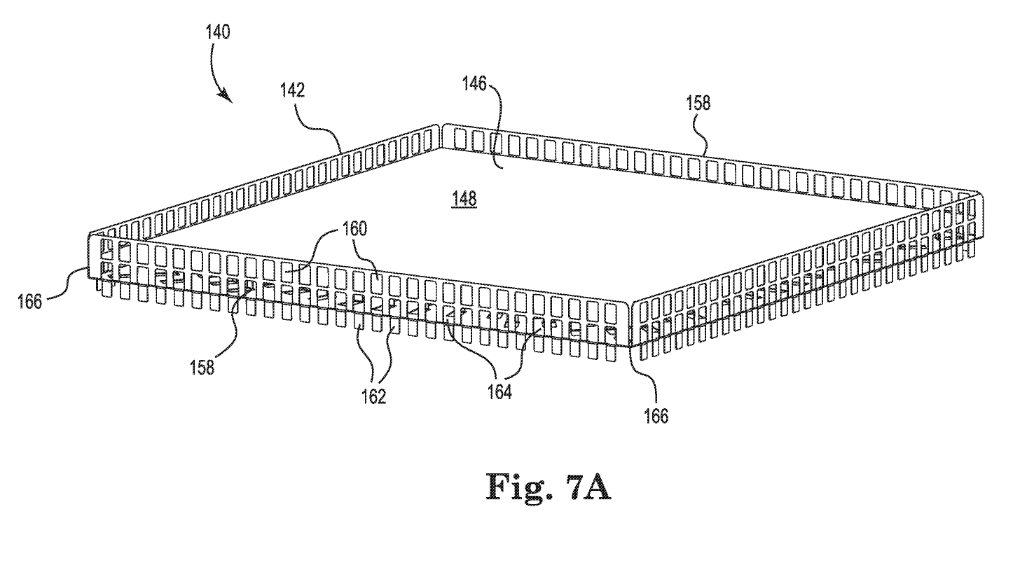

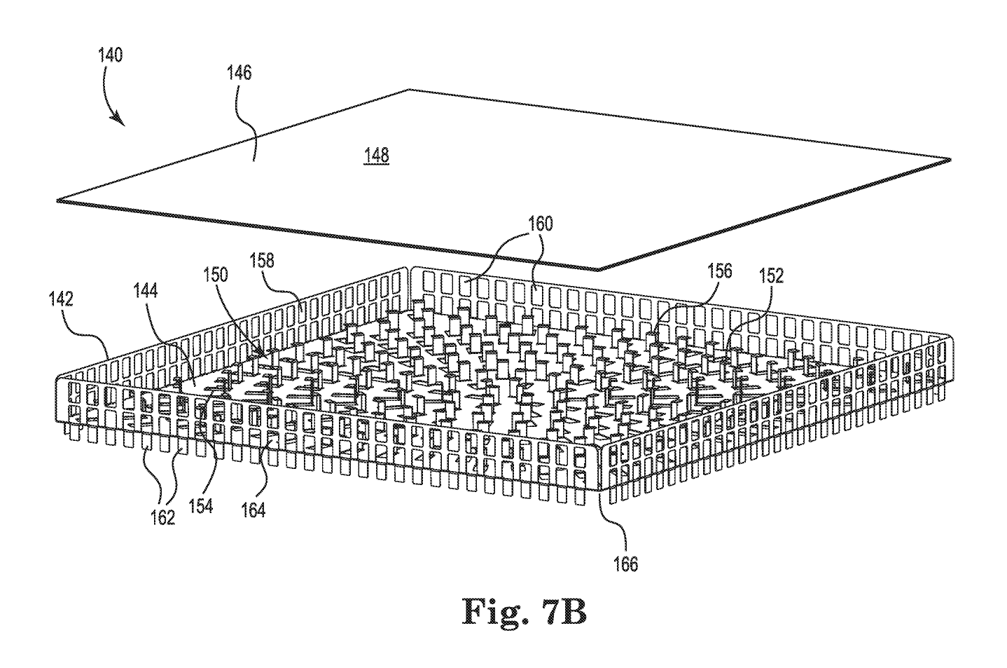

FIGS. 7A and 7B show another approach for providing another embodiment of a composite mirror panel 140 with a perimeter skirt 142 that has features that project both upward and downward from panel 140. As shown in FIGS. 7A and 7B, composite mirror panel 140 includes bottom skin 144, top skin 146, and core 150. Top skin 146 includes top reflective surface 148 for redirecting sunlight at a target (not shown). Core 150 comprises a plurality of spaced apart core elements 152 that are integrally formed from bottom skin 144. The core elements 152 are folded upward, leaving openings 154 in the bottom skin 144. The tips 156 of elements 152 are folded over to provide tabs to attach the elements 152 to the top skin 146. Core elements 152 couple skins 144 and 146 in spaced apart fashion to form a composite structure.

Perimeter skirt 142 comprises walls 158 that are integrally formed with bottom skin 144 and are folded upward to extend above top skin 146. Walls 158 include upper perforations 160. Corners 166 are open but optionally can be wholly or partially sealed. In addition to walls 158 that extend upward, tabs 162 are integrally formed from walls 158 and are folded to project downward from bottom skin 144. Forming and folding of the tabs 162 leaves lower perforations 164 in walls 158. Perimeter skirt 142 also function as heat exchange fins to facilitate thermal exchange and help the composite mirror panel 140 to maintain thermal equilibrium with the environment.

While the skirts shown in the figures all completely surround the composite mirror panel, an embodiment that provides one or more partial skirt(s) is also suitable in some embodiments. One embodiment, for example, only provides a skirt on the higher end of the composite mirror. Likewise, an embodiment may include a skirt(s) that may either extend towards the front of the mirror, or towards the back of the mirror, or both. An embodiment may include a frontward-facing skirt along zero or more edges or portions of edges while including a rearward-facing skirt along zero or more edges or portions of edges. Skirts may be placed so that they are generally normal to the mirror skins, or they may be at some angle. Skirts may also be curved or bent into any useful shape. Any skirt or portion of a skirt may include perforations, fins, or other porosity features. Any porosity may be used. Porosities between 20% and 80% are used in suggested embodiments.

As described herein, one approach for deploying core elements between the top and bottom skins of a composite mirror panel involves laying out the core elements in arrays on concentric rings around a common, central site such as attachment site 44 of composite mirror panel 36 described above. Other deployment strategies also are suitable. As one example of an alternative deployment strategy, core elements may be deployed along one or more curves with a generally involute shape that generally spiral outward with increasing radius from the common reference site central to the curve. Using this method, the core elements are positioned along at least one involute curve. The spacing between the core elements may vary. More desirably, to ease design analysis, generally equal length curve segments separate the core elements. A desirable characteristic of involute curves is that the distance between adjacent layers of the curve may remain constant. This may be true for a single involute curve, as well as for multiple involutes arranged in a symmetrical polar array.

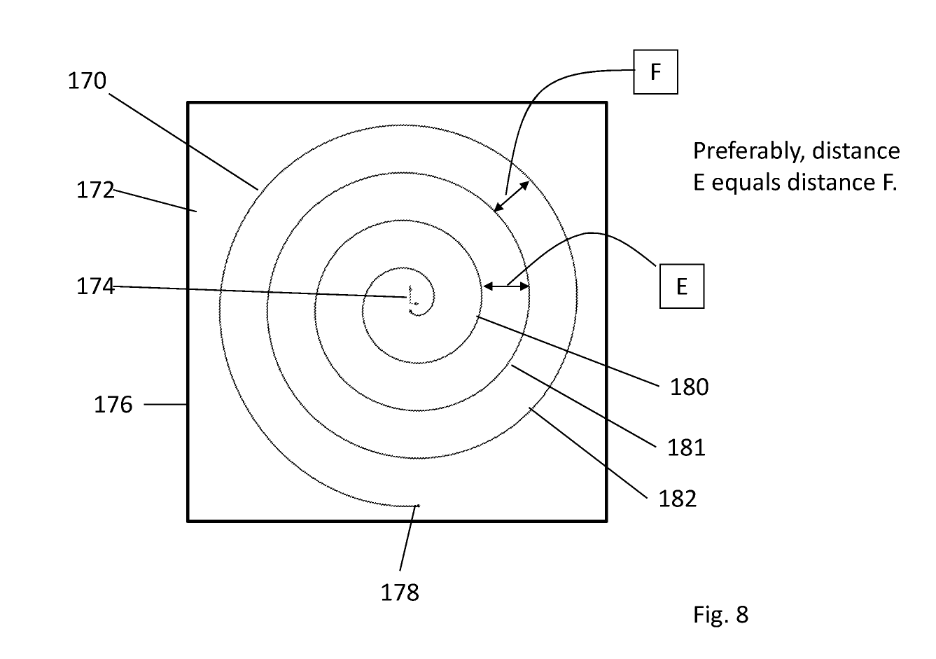

FIG. 8 shows an exemplary curve 170 with a generally involute shape envisioned for core layout on a sheet 172 that will be used to form a bottom skin. Involute curve 170 begins at the centrally located attachment site 174 and spirals outward toward the perimeter 176 of sheet 172. Spacing between the curve end 178 and the sheet perimeter 176 to allow a perimeter skirt (not shown) to be formed if desired. The distance between turns 180 and 181 is shown by the distance E. The distance between turns 181 and 182 is the distance F. Although the distances E and F may be different (similarly, the distance between adjacent turns of the curve 170 may be different as well), it is more desirable that the distances E and F be the same (similarly the distances between the other turns of curve 170 desirably also are the same as distances E and F).

Conceptually, the involute curve is not truncated when it reaches the perimeter 176 of sheet 172. The curve may go outside the perimeter and then return to the interior. A typical embodiment will provide core elements along any portion of the curve that falls within the perimeter 176. Portions of the curve that go outside the perimeter are not included in the embodiment.

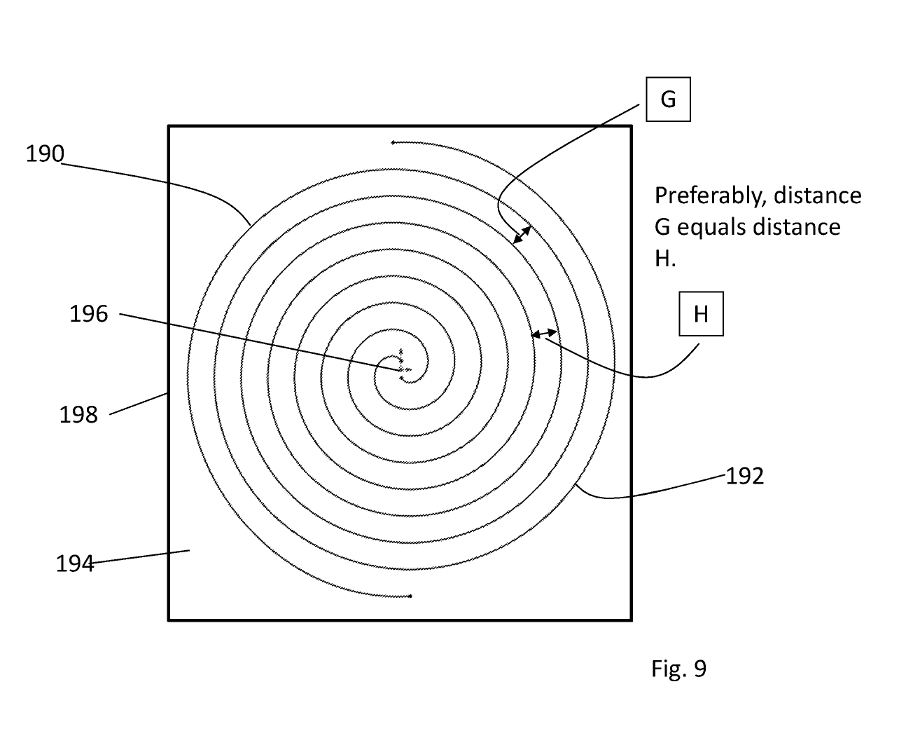

More than one involute curve may be envisioned on a sheet in order to deploy core elements on that sheet. For example, FIG. 9 shows involute curves 190 and 192 envisioned on a sheet 194 that will be used to lay out and form core elements that are integral with bottom skin. Curves 190 and 192 start proximal to the common reference site 196 (corresponding to an attachment site at which the bottom skin is couple to other heliostat structure) and spiral outward toward the perimeter 198 of sheet 194. Although the distances G and H may be different, it is more desirable that the distances G and H be the same.

Using involute curves to lay out and deploy core elements provides many advantages. The shape of the involute curve, the number of curves, and the spacing of core elements along the curves provide flexibility to tune the arrangement of the core elements to meet the desired composite panel requirements. A characteristic of core elements arranged along an involute curve is that each element on that curve is located at a different radial distance from the central reference site. In other words, looking at a single involute curve, a circle centered at the reference site will only cross through the involute curve at a single location. This is different than the arrangement of tabs on a concentric arc, where a plurality of elements are at a given distance, and the number of elements at that distance may be proportional to the length of the arc at that distance. This inherent characteristic of the involute layout may simplify the process of laying out the core elements and make it more straight-forward to choose an appropriate stiffness design for each core element. This approach also may make it easier to match the panel shear stiffness to a desired profile. Additionally, the involute arrangement tends to randomize the core element locations such that the bending stiffness characteristics of the composite panel may be improved. The involute layout approach provides a convenient method for laying out the core elements in a regular pattern while meeting the functional requirements of a composite sandwich panel.

Another advantage of laying out core elements in concentric arrays or on an involute is that the tab locations can be configured to accommodate stiffening ribs in the bottom skin to enhance stiffness of the skin. Creating a back skin with increased stiffness may be particularly desirable for embodiments that incorporate some forms of core element geometries, such as the angled core elements described below that help to provide stiffness characteristics that vary with temperature.

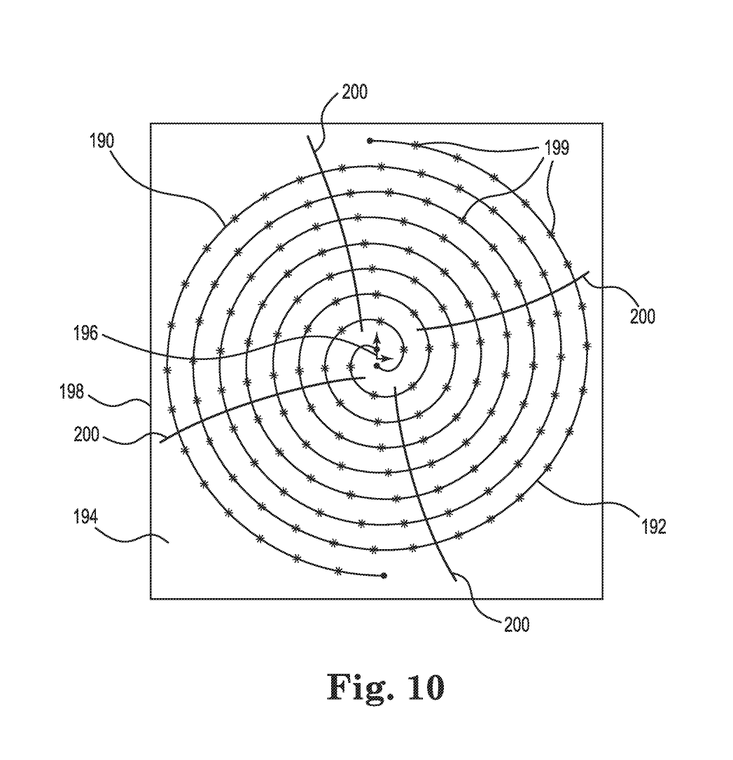

For example, FIG. 10 shows specific core elements sites 199 selected on curves 190 and 192 of FIG. 9 on which to form integral core elements (not shown). The spacing of the core element sites 199 allows one or more strengthening ribs 200 to be provided in a manner that does not conflict with the formation and function of the core elements to be formed. The ribs 200 may be separate components that are attached to sheet 194 or may be integrally formed from sheet 194 such as by folds or corrugations.

The present invention provides many strategies for tuning the shear stiffness profiles of composite panels. These strategies may be used singly or in combination. One tuning strategy involves orienting the core elements perpendicular to radial lines between the core elements and the common reference site around which the core elements are deployed. To achieve a stiffness profile in which shear stiffness generally decreases with increasing distance from the reference site, the width of the core elements may be used as a tuning tool. Greater widths are used near the common site for greater stiffness. Narrower widths are used farther from the common reference site.

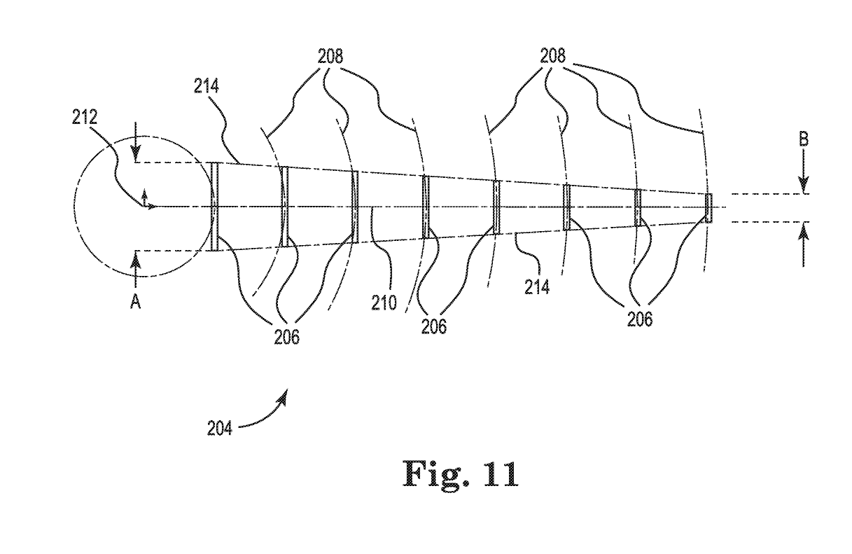

An exemplary radial deployment is shown schematically in FIG. 11 where a plurality of core elements 206 are arranged on concentric rings 208 around a common reference site 212. For purposes of illustration and to represent the plan in compact fashion, the core elements 206 are shown as being on a common radial line 210. Also, only a single core element 206 is shown on each ring 208. In actual practice a plurality of core elements would be deployed on each ring 208, and elements would be deployed on a plurality of radial lines rather than all being only on a single radial line 210. As shown, the core element 206 closest to the common reference site 212 has the greatest width A for the greatest stiffness. The core element 206 farthest from the common reference site 212 has the narrowest width B. The intermediate core elements 206 have widths that increasingly narrow in linear fashion with distance from site 212 as shown by the linear boundary lines 214.

The radial deployment plan 204 shown in FIG. 11 may be suitable in many embodiments. However, even though the width of the core elements 206 of FIG. 11 decreases linearly, the shear stiffness might not be tuned in a similar linear fashion. In some modes of practice where it is desired to attain a preferred stiffness profile that decreases linearly with increasing radial distance from the common reference site, it may be desirable that the width of each core element must decrease nonlinearly, e.g., exponentially or by some other factor of Xn where X is distance and n is greater than 1, to account for both the decreasing stiffness profile, and the increasing number of tabs being deployed. A practical difficulty with requirement nonlinear tuning design is that the outermost core element widths may become impractically narrow from a manufacturability standpoint.

Another deployment strategy radially staggers core elements so that at least some of the core elements are not radially aligned with a core element on an adjacent concentric ring. A staggered deployment can help to maintain core element density (i.e., the number of core elements per unit area) while facilitating concentric rings having elements with successively narrower widths with increasing distance from the reference region or site. The angular spacing between elements on a given ring can be easily tuned, so there is no need to constrain elements on adjacent rings to remain on common radial lines. As still another deployment strategy, the core elements may be deployed on a rectangular or other grid, involute curves, or the like, rather than being deployed in concentric rings.

Advantageously, the present invention provides numerous tuning strategies to allow core elements to be more easily manufactured without tab widths being too narrow for easy manufacturability. In other words, desired stiffness characteristics can be achieved using one or more of a variety of methods. For example, in addition to or as an alternative to changing the width, the core elements could be notched or have windows added. Generally, larger notches or larger windows would provide core elements with lower stiffness characteristics. If increased stiffness were desired, added or stamped features such as ribs could be added to a core element. These strategies may be used singly or in combination.

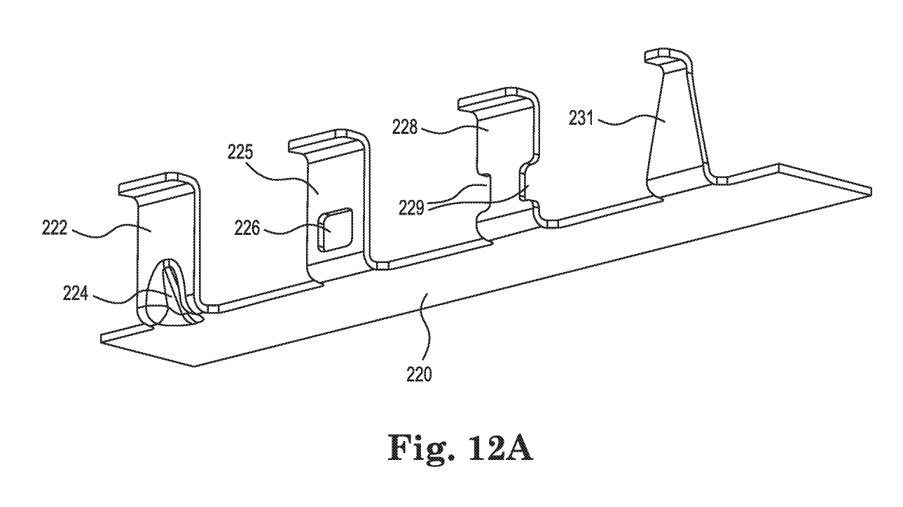

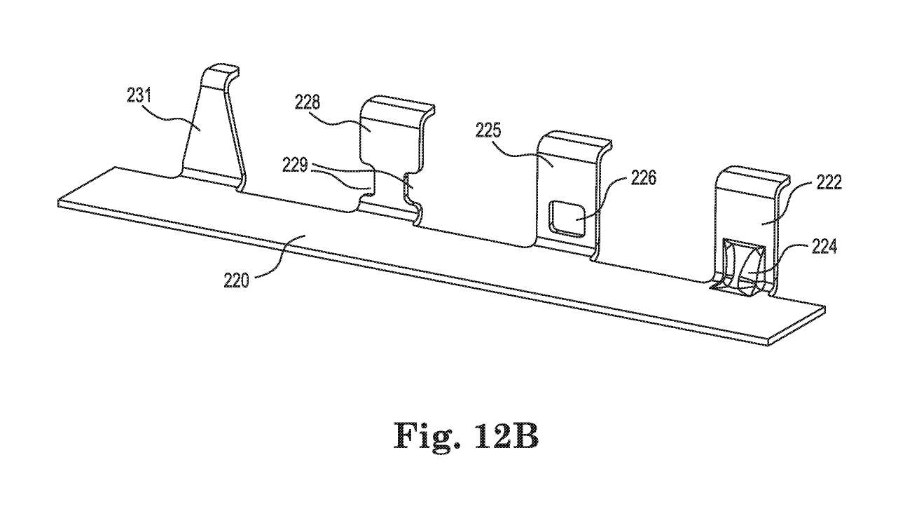

FIGS. 12A and 12B show how the stiffness characteristics of core elements can be tuned using such features. FIGS. 12A and 12B show a portion of a sheet 220 in which an integral core element 222 is formed with rib 224 to help add stiffness. Integral core element 225 is formed with a window 226 to reduce stiffness. The stiffness can be further tuned by increasing the size of the window to reduce stiffness further or reducing the size of the window to reduce stiffness by a lesser degree. Integral core element 228 is formed with notches 229 to reduce stiffness. The size of the notches 229 can be increased to reduce stiffness further or decreased for a lesser reduction of stiffness. Integral core element 231 is tapered to reduce stiffness. Note that the overall width of core elements 222, 225, 228, and 231 is the same, but the features of the elements are adjusted to tune stiffness.

In some modes of practice, particularly with respect to large composite mirror panel embodiments, it may be the case that core elements arranged perpendicularly to a radial line between the elements and a common reference location are not able to provide enough shear stiffness to adequately resist bending loads generated by gravity and wind, while still meeting slope error targets. The limiting factor might be the thickness of the sheet material used to form the bottom skin and core elements because the sheet thickness is one factor affecting stiffness. The stiffness is proportional to the moment of inertia of the core element in a radial direction, which equals I= 1/12 bh³, where b is the core element width side to side and h is the core element thickness, which also is the bottom skin thickness in many embodiments.

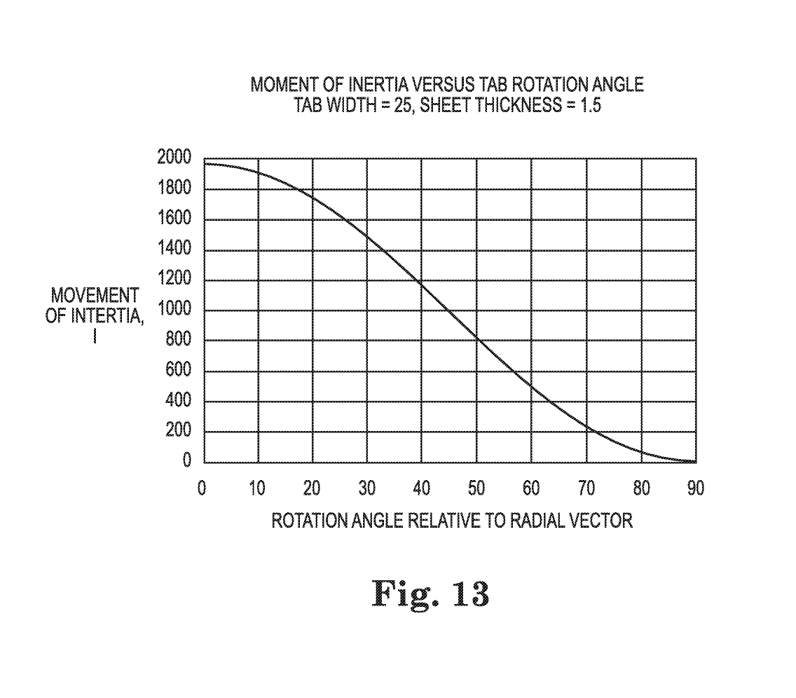

One alternative approach for increasing the panel stiffness is to rotate the core elements relative to a radial line between the core elements and the common reference location. Depending on the core element cross sectional geometry, even reducing the angle from 90 degrees (perpendicular to a radial line) to 80 degrees (10 degrees off the radial line) could result in a significant moment of inertia increase in the radial direction. FIG. 13 is a plot which shows the moment of inertia I for a core element of a given geometry as a function of rotation angle and is represented by the equation

I=(bd/12)*(b² cos²α+d² sin²α)

where α is the rotation angle of the tab relative to a radial line, b is the tab width (25 mm in this example), and d is the sheet thickness (1.5 mm in this example). We define α=90 degrees for a tab oriented perpendicular to a radial line.

FIG. 13 shows that the moment of inertia for this particular core element geometry can be decreased by a factor of 278 (useful range is between 7 and 1953) simply by rotating the core element relative to a reference radial line between 0 and 90 degrees. This should provide ample adjustability to dial in the desired stiffness values while still meeting other preferred requirements related to sandwich panel manufacturability.

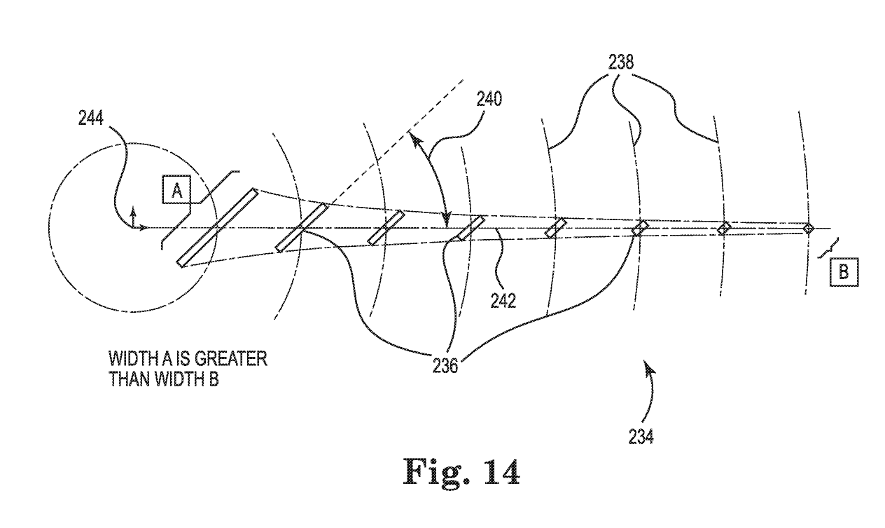

There are many options for angling the tabs to provide the desired stiffness characteristics. One option is to rotate all the core elements to the same angle to help increase the peak panel stiffness value to resist gravity and wind loads. This could be practiced in combination with adjusting the widths of the core elements as a function of radial location to help meet the stiffness profile target. FIG. 14 schematically illustrates this deployment plan 234. A plurality of core elements 236 are deployed on concentric rings 238 (or turns 238 of an involute curve) at a common angle 240 with respect to a reference radial line 242 between the elements 236 and the common reference location 244. The width of the elements 236 gradually is reduced from a width of A proximal to the location 244 to a narrower width B distal from the location 244.

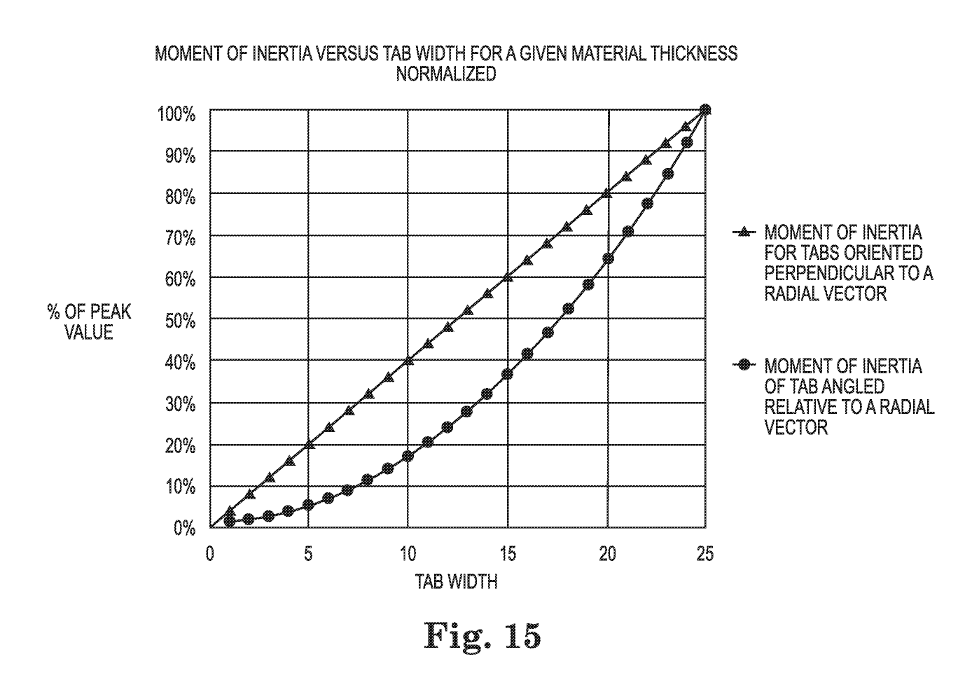

The approach shown in FIG. 14 has many advantages. The moment of inertia of a core element oriented perpendicular to a radial reference line between the element and the common reference location decreases linearly as the width b of the tab decreases. This is based on the equation I= 1/12bh³. However, the moment of inertia of an angled tab decreases more than linearly with b. This characteristic helps maintain a higher core element width for manufacturability while still allowing the core elements to meet desired stiffness requirements. See the graph in FIG. 15, which plots the change in moment of inertia of tabs angled at a fixed angular value versus perpendicular tabs as a function of tab width. These curves are normalized for comparison purposes. Note that in FIG. 15 the stiffness reduction rate of perpendicular tabs is proportional to tab width. However, the stiffness reduction rate of angled tabs decreases more than linearly. Therefore, one can achieve a greater percentage reduction of stiffness with angled tabs than with perpendicular tabs for a given reduction in tab width. Referring to the graph in FIG. 15, this means that a 50% reduction in stiffness of a perpendicular tab results in a width reduction from 25 to 12.5 mm. On the other hand, the width of an angled tab would only need to be reduced to approximately 17.5 mm to achieve this same percentage reduction in stiffness. This has beneficial implications from a manufacturability standpoint, as previously discussed.

As another advantage, when each core element is angled the same amount and in the same direction relative to a radial line between that element and the common reference location around which the plurality of core elements is deployed, then the core elements will tend to move in concert due to differential thermal expansion (or contraction) of the skins. This should help reduce stresses in the facet assembly by allowing relatively unfettered, in-plane rotation of the skins relative to one another. This concerted movement is expected to produce a more uniform stress gradient, tending to minimize the resultant slope errors in the mirror. Rotation of the mirror skins generally has no practical effect on the optical function of the composite mirror panel. Rather this rotation is a useful degree of freedom that the embodiment uses to help relax thermal stresses.

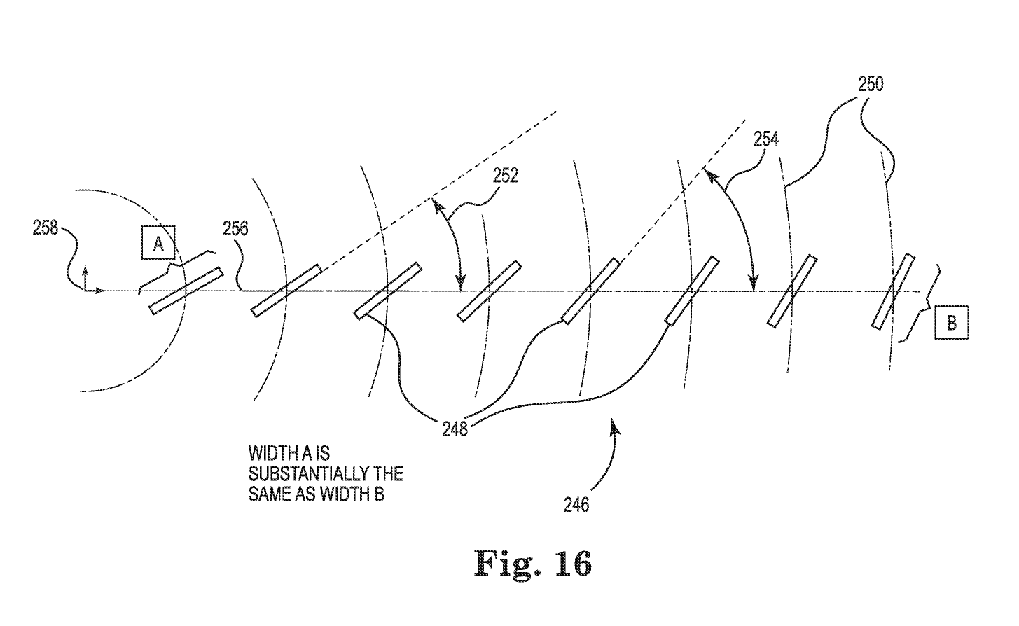

Another approach for angling the core elements to boost the peak panel stiffness, while still meeting the desired radial stiffness profile, is to progressively increase the tab angle with increasing radial distance from the common reference location around which the elements are deployed. FIG. 16 schematically shows a deployment plan 246 implementing this approach. A plurality of core elements 248 are deployed on concentric rings 250 (or turns 250 of an involute curve) at a plurality of angles (represented by angles 252 and 254) with respect to a reference radial line 256 between the elements 248 and the common reference location 258. Note how the angles 252 and 254 increase with increasing distances from common reference location 258. The widths of the elements 248 are substantially the same. This is shown by width A being the same as width B.

An advantage of the approach of FIG. 16 is that the tab width may remain constant while still achieving a desired stiffness profile requirement throughout the composite mirror panel. One possible drawback, however, is that under differential thermal expansion of the skins, the flexing core elements 248 may tend to work against each other. Core elements located at one angular orientation with respect to the common location 258 may attempt to rotate the skins to an angular location different from that preferred by the core elements at a different radial orientation. If the core elements work against each other, this could cause in-plane stress loads that could negatively impact slope error.

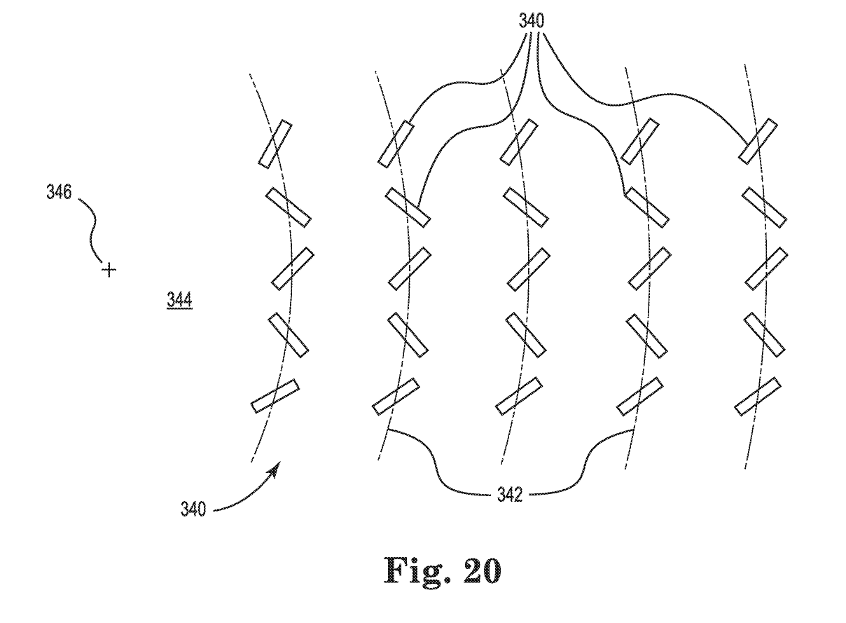

There are at least two ways to mitigate the potential of such slope errors. First, the angular orientation of core elements may be alternated to be clockwise and counterclockwise with respect to the radial reference lines between the elements and the common location site. This alternation would help to balance out the skin stresses. This approach is shown in FIG. 20 where core elements 340 are deployed in arrays on concentric rings 342 on sheet 344. The angular orientation of the elements 340 with respect to a common, centrally located reference location 346 alternates at approximately +1-45 degrees. An additional strategy is offered when using glass sheets to form the top skin of a composite mirror panel. Advantageously, the in-plane stiffness of the glass skin is very high. Due to this stiffness, the stresses induced by variable core element angles might not result in significant slope errors.

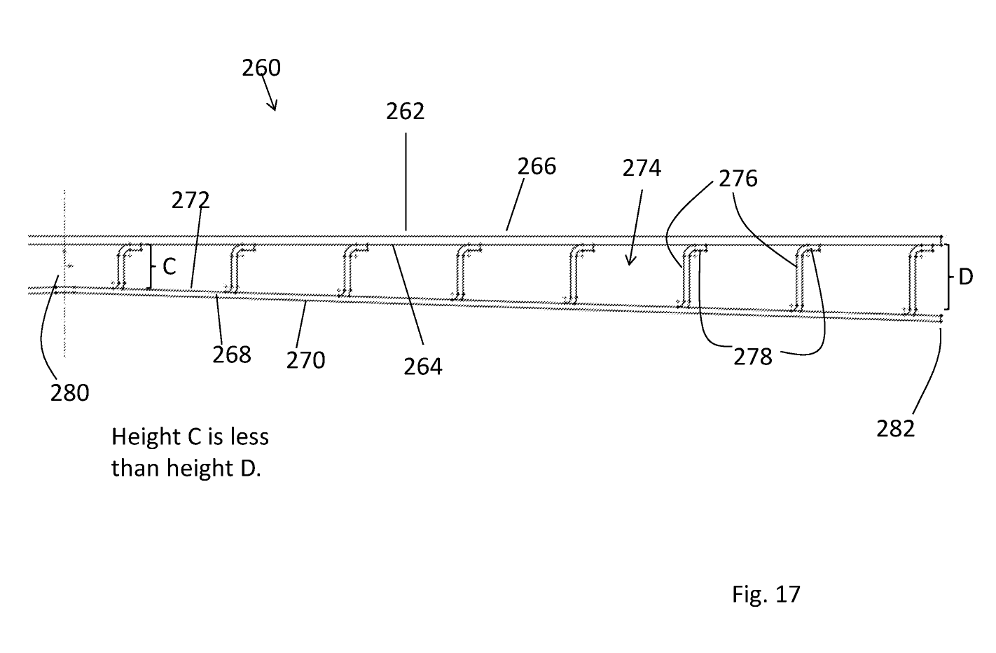

Another strategy to help provide decreasing shear stiffness with increased distance from a common reference location is to vary the lengths of the core elements as a function of the distance. Generally, the elements tend to flex more easily, and stiffness is reduced, with increased core element height. Using a variation in heights in this fashion will tend to result in a bottom skin that is not parallel to the front skin. This approach is shown in FIG. 17. A portion of a composite mirror panel 260 is shown in cross-section. Composite mirror panel 260 includes a top skin 262 having a bottom surface 264 and a top reflective surface 266. A bottom skin 268 has a bottom surface 270 and a top surface 272. Panel 260 includes a centrally located attachment site 280 at which panel 260 is attached to other heliostat components (not shown). Core 274 is coupled to and supports skins 262 and 268 in spaced apart fashion. Core 274 includes a plurality of core elements 276. Core elements 276 are integrally formed from bottom skin 268 and are bent upward from bottom skin 268 toward top skin 262. Tips 278 of the core elements 276 are bent over to form tabs in order to help couple the core elements 276 to the bottom surface 264 of the top skin 262. The height of the core elements 276 gradually increases with increasing distance from the centrally located site outward toward the periphery 282 of the panel 260. As a consequence of the increasing height of the elements 276, the distance C between the skins 262 and 268 at the central attachment site 280 is less than the distance D proximal to the periphery 282.

Advantageously, principles of the present invention may be used to provide core structures that not only help to provide shear stiffness profiles but also help to provide the panels with stiffness characteristics that vary in a desired manner with temperature changes. For example, additional principles of the present invention can be used to intentionally adjust the mirror shape as a function of temperature. This can help to bias the slope error performance to a particular temperature range. For example, it might be desirable to have the mirrors perform better in the winter when the incident solar radiation is lower. This is contrasted to the summer when excess available solar energy may require that some heliostats be actively off-pointed to prevent the target from receiving too much incident flux.

One mode of practice useful to achieve this is to use core elements that are not perpendicular to the skins. Radial motion between the skins due to temperature changes will tend to either push the skins apart, or pull them together, depending on the tab angle and the direction of relative motion between the skins. By selectively angling the core elements relative to the skins, it is possible to adjust the mirror shape as a function of temperature. For example, the mirror panel assembly might be designed such that it takes on a concave profile in colder temperatures and moves closer to a flat shape as it gets hotter. This idea is well suited to the composite sandwich panel construction techniques of the present invention because there are a large number of core elements to help control the mirror shape.

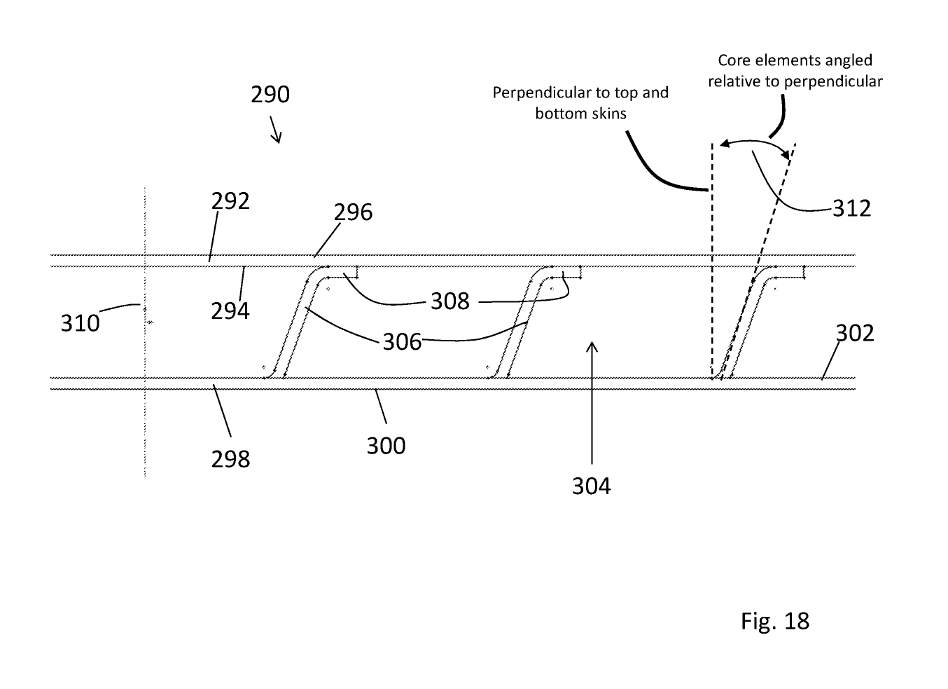

FIG. 18 shows how this strategy is implemented. A portion of a composite mirror panel 290 is shown in cross-section. Composite mirror panel 290 includes a top skin 292 having a bottom surface 294 and a top reflective surface 296. A bottom skin 298 has a bottom surface 300 and a top surface 302. Panel 290 includes a centrally located attachment region 310 at which panel 290 is attached to other heliostat components (not shown). Core 304 is coupled to and supports skins 292 and 298 in spaced apart fashion. Core 304 includes a plurality of core elements 306. Core elements 306 are integrally formed from bottom skin 298 and are bent upward from the bottom skin 298 toward top skin 292. Tips 308 of the core elements 306 are bent over to form tabs in order to help couple the core elements 306 to the bottom surface 294 of the top skin 292. The core elements 306 are deployed at an angle 312 relative to a perpendicular angle between skins 292 and 298. As a consequence of the angle, the skins 292 and 298 move responsively to temperature changes in a designed fashion in order to tune the performance of the panel for different temperature conditions.

Other embodiments of core elements may be used as core features in composite mirror panels of the present invention. For example, instead of forming and folding core elements from the bottom skin as described above, the core elements could be features, e.g., cylindrically shaped features, that are punched or drawn upward from the bottom skin sheet. Depending on the radial location, the diameter and/or length of the features could change as needed to provide required shear stiffness characteristics.

The present invention further provides strategies for attaching the composite mirror panels to other heliostat components. The strategies are useful both for large heliostats that use many individual mirror facets attached to a common frame, as well as on smaller heliostats that have a single mirror facet assembly.

In some heliostat designs multiple mirror panel assemblies are mounted to a common base structure. In turn, that base structure is attached to a common drive mechanism that articulates a plurality of composite mirror panels around two axes in order to track the sun and redirect sunlight onto a desired target. In this type of layout, multiple, distributed mounting points connect each mirror panel assembly to the underlying heliostat structure. In many instances this is accomplished such that the mirror panel assemblies plus the structure form a rigid assembly. This approach is what is typically done for larger heliostats.

Attaching composite panels to a large heliostat could be problematic if the common frame structure and back skin of the panel are made from different materials. This could cause slope errors due to differential thermal expansion. One way to remedy this is to provide compliance in the attachment points between the heliostat structure and the composite panel. Another approach is to make the back skin of the composite panel from the same material as the coupling structure.

The mounting features between the common frame structure and a panel could take the form of threaded rods, folded sheet metal tabs, or any convenient attachment methods. The attachment of the mounting features to the back of the panel could be achieved with the use of hardware, adhesive, welding, or other fastening method. The mounting features also may be integral with the composite mirror panel as described below.

Another heliostat approach uses a dedicated drive mechanism for each mirror panel assembly. In this arrangement the mirror panel assembly may be self-supporting, since it is typically attached to the mechanism near its center with its edges overhanging the drive. This is similar to a cantilever beam structure. This is the approach typically used for small heliostats.

For small heliostats, the attachment interface typically takes place between a rotational output shaft on the heliostat and the rigid backing structure that supports the reflector. The most common attachment method uses standard hardware, such as nuts or bolts, which allow convenient installation and removal of the facet assembly. The composite mirror panel assembly of the present invention benefits from being attached to a small heliostat drive with additional, added features. One preferred approach to attachment is to add a folded sheet metal component to the back skin of the composite panel. The component contains mounting features that interface with mating components on the heliostat output shaft. Connection of the folded sheet metal component to the panel skin could be achieved with adhesive, spot welding, screws, or any number of other fastening methods. If the back skin of the composite panel and the heliostat output shaft are made from different materials, it may be preferable to limit the rigid attachment between the two sub-assemblies to a single location, to help mitigate the effects of differential thermal expansion.

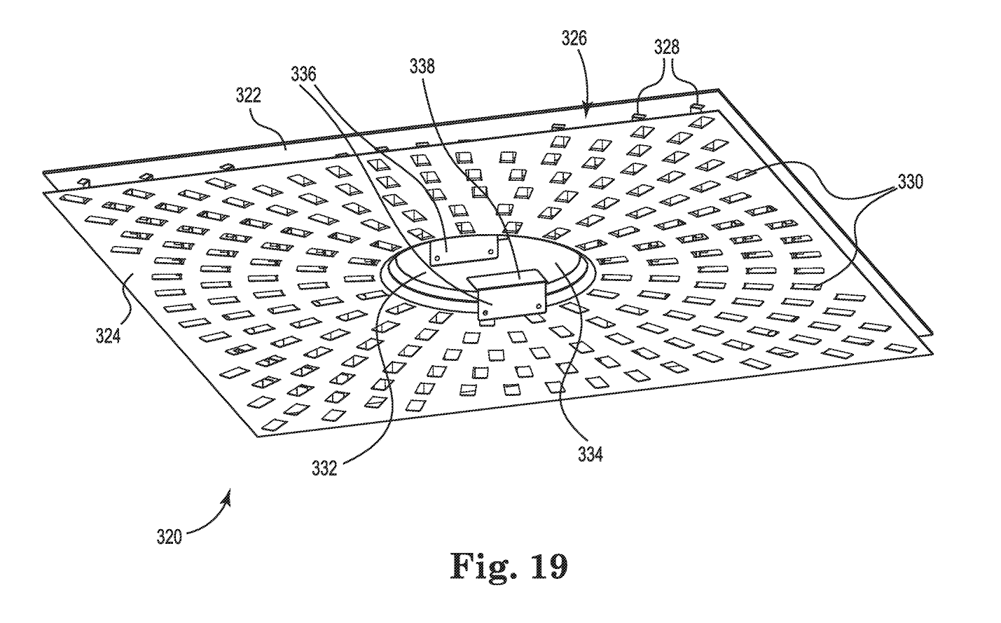

It may also be feasible to create attachment features from the back skin of the composite panel itself. Such integral features could be stamped or formed into the sheet at the same time that the core elements are created, if desired. This approach is shown in FIG. 19.

As shown in FIG. 19, composite mirror panel 320 has top skin 322 with a reflecting top surface (not shown in the figure), a bottom skin 324, and a core 326. Core 326 includes a plurality of core elements 328 that are integrally formed from bottom skin 324 and folded upward to couple the core elements 328 to the top skin 322. Perforations 330 incidentally result in the bottom skin 324 from forming and folding the core elements 328 in this manner. A recess 334 is integrally formed into a central region of the panel 320. The central attachment site 332 is located in this recess 334. Other heliostat components connect to panel 320 at the attachment site 332. Mounting tabs 336 are integrally formed from the bottom skin 324 in the area of the recess 334. Mounting tabs 336 are folded downward to allow engagement with other heliostat components (not shown). The formation of the mounting tabs 336 results in perforations 338 being incidentally formed in the recess 334. An advantage of recess 334 is that it allows the center of gravity of the composite panel assembly to be moved lower and closer to a pivot axis, helping to reduce the torque output requirements of the heliostat drive mechanism.

All patents, patent applications, and publications cited herein are incorporated by reference in their respective entireties for all purposes. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. An articulating heliostat comprising a mirror panel assembly, comprising:
(a) a bottom component comprising (i) an upper surface, (ii) a lower surface, and (iii) at least one reference site;
(b) a top component that is spaced apart from the bottom component and that has a lower surface and a reflective upper surface effective to redirect incident sunlight; and
(c) a core component interposed between the bottom component and the top component and comprising a plurality of spaced apart core elements that couple the bottom component to the top component in a spaced apart fashion, wherein the core elements are provided in a manner such that at least a portion of the mirror panel assembly has a relatively higher shear stiffness proximal to the at least one reference site and a relatively lower shear stiffness distal from the at least one reference site.

2. The assembly of claim 1, wherein the bottom component and the top component have different coefficients of thermal expansion.

3. (canceled)

4. The assembly of claim 1, wherein the bottom component comprises aluminum.

5. The assembly of claim 1, wherein the top component comprises a reflective sheet comprising polished aluminum.

6. (canceled)

7. The assembly of claim 1, wherein the top component comprises a reflective sheet comprising a float glass mirror and a fiber reinforced coating on the float glass mirror.

8. The assembly of claim 1, wherein the top component and the core elements are bonded together with a thermally conductive adhesive.

9. The assembly of claim 1, wherein the core component has a relatively higher shear stiffness proximal to an attachment site and a relatively lower shear stiffness proximal to a perimeter of the mirror panel assembly.

10. The assembly of claim 1, wherein the bottom component comprises a bottom skin having a centrally located attachment site.

11. (canceled)

12. The assembly of claim 1, wherein the core component has tuned stiffness characteristics.

13. (canceled)

14. The assembly of claim 1, wherein the core elements have differing heights.

15. The assembly of claim 1, wherein at least one of the core elements comprises a notch or a window.

16. A composite panel assembly, comprising:
(a) a first skin;
(b) a second skin; and
(c) a core coupling the first skin to the second skin in spaced apart fashion, wherein the core comprises a plurality of spaced apart core elements that are integrally formed from at least one of the first and second skins, and wherein the core elements are configured to provide the composite panel with a shear stiffness that decreases with increasing distance from a reference site of the composite panel assembly.

17. The panel assembly of claim 16, wherein the first skin and the second skin comprise a laminate structure formed from two or more sheets.

18. The assembly of claim 16, wherein the first skin is integrally formed with the core elements.

19. The assembly of claim 16, wherein a width of the core elements decreases with increasing distance from the reference site.

20. A concentrating solar power system, comprising:
(a) a central target; and
(b) a plurality of articulating heliostats that redirects and concentrates sunlight onto the central target, wherein at least one of the heliostats comprises a mirror panel assembly, and wherein the mirror panel assembly comprises:
(i) a bottom component comprising (I) an upper surface, (II) lower surface, and (III) a reference site;
(ii) a top component that is spaced apart from the bottom component and that has a lower surface and a reflective upper surface effective to redirect incident sunlight; and
(iii) a core component interposed between the bottom component and the top component and comprising a plurality of spaced apart core elements that couple the bottom component to the top component in a spaced apart fashion, wherein the core elements are provided in a manner such that at least a portion of the mirror panel assembly has a relatively higher shear stiffness proximal to the reference site and a relatively lower shear stiffness radially distal from the reference site.

21. The system of claim 20, wherein the reference site coincides with an attachment site of the bottom component.

22. (canceled)

23. (canceled)

24. The system of claim 20, wherein the core elements are arranged in concentric rings around the reference site.

25. The system of claim 20, wherein the core elements are arranged in a staggered deployment around the reference site.

26. The system of claim 20, wherein the core elements are orientated in a plurality of angular configurations relative to the reference site.

27. (canceled)

28. The system of claim 20, wherein the core elements are deployed along one or more curves with a generally involute shape that generally spiral outward with increasing radius from the reference site.

29. The system of claim 20, wherein the core elements are deployed along two or more curves with a generally involute shape that generally spiral outward with increasing radius from the reference site.

30. The assembly of claim 20, wherein the core elements have an angular orientation that are alternated clockwise and counterclockwise with respect to a radial reference between the core elements and the reference site.

31. A method of making a heliostat, comprising the steps of:
(a) providing a mirror panel assembly, comprising the steps of:
(i) providing a bottom skin having a bottom surface and a top surface;
(ii) providing a top skin having a bottom surface and a reflective top surface effective to redirect incident sunlight;
(iii) identifying at least a first reference site on the bottom skin; and
(iv) using a plurality of spaced apart core elements to couple the bottom skin to the top skin in a spaced apart fashion such that the mirror panel assembly has a relatively higher shear stiffness proximal to a first reference site and a relatively lower shear stiffness distal from the first reference site; and
(b) attaching an additional heliostat component to the reference site of the mirror panel assembly.

32. (canceled)

33. (canceled)

34. The assembly of claim 31, further comprising a perimeter skirt extending from the bottom skin.

35. The assembly of claim 34, wherein the perimeter skirt comprises perforations.

36. (canceled)
